(19) United States
(12) Patent Application Publication
(10) Pub. No.: US 2023/0111817 A1
(43) Pub. Date: Apr. 13, 2023

(54) FINGERPRINTED MEDIA TRIGGERING VIRTUAL REPOSITORY

(71) Applicant: Mack Craft, Denver, CO (US)

(72) Inventor: Mack Craft, Denver, CO (US)

(21) Appl. No.: 18/064,337

(22) Filed: Dec. 12, 2022

Related U.S. Application Data
(63) Continuation-in-part of application No. 17/248,185, filed on Jan. 13, 2021, now Pat. No. 11,526,472.
(63) Continuation-in-part of application No. 18/051,273, filed on Oct. 31, 2022.

(51) Int. Cl. G06Q 10/087; G06Q 30/0214; G06V 20/40; G06V 40/10

(52) U.S. Cl. CPC G06Q 10/087; G06Q 30/0214; G06V 20/41; G06V 40/10

(57) ABSTRACT

A virtual repository system with robust item management may automatically derive item data from accessed current and past transactions. The system may interface with merchant systems to receive current and archived transaction data, scans emails for current and past transaction data, monitors browser data for online transaction data, and accepts manual input. Data obtained from all sources is collated and stored in a cache for user validation, whereupon it is added to a virtual repository. Triggers prompt the delivery of responsive results including information from shared virtual repositories. Triggers may include video or sound, from which item records may be identified and reported to an inquiring user.

### RELATED APPLICATION

This application is a continuation in part of and claims the benefit of priority of U.S. Nonprovisional Application 18/051,273 filed Oct. 31, 2022 and U.S. Nonprovisional Application 17/248,185 filed Jan. 13, 2021, which is a nonprovisional of and claims the benefit of priority of U.S. Provisional Application 62/974,091 filed Nov. 13, 2019, the entire contents of which are incorporated herein by this reference and made a part hereof.

### FIELD OF THE INVENTION

This invention relates to a computing system configured to automatically providing a link to a virtual repository record in response to a trigger and based upon video or sound recognition.

### BACKGROUND

Individuals own, possess, seek and sell various products. As a nonlimiting example, individuals own and possess clothing items. Some individuals may want to purchase additional clothing items, or sell or donate clothing items. Many individuals are unaware of the vast array of clothing items they currently possess, or when they acquired the items, or from whom they acquired the items. They may not sell or donate unused clothing simply because they forgot they even possess the unused clothing and/or because they cannot be bothered with the hassle of selling and/or donating. Unused clothing consumes valuable closet space, adds to clutter, and requires effort during relocation.

Individuals may want to add garments to their wardrobe. They may want to add a garment that matches another garment they already possess. They may want to add garments that they admired when the garment was worn by another person. They may want to add garments that another person possesses, even if the other person has not worn the garment. They may want to inform others of garments they would like to add to their wardrobe. They may want to inform others of garments they possess and believe others may want to acquire from a merchant.

Individuals may also want to gift garments to a friend, family member, acquaintance or significant other. Without knowing the recipient’s size, style and existing wardrobe, any such gift may be a roll of the dice. With knowledge of the recipient’s size, style and existing possessions, a gift giver would stand a much greater chance of success.

Individuals may want to sell or donate garments. Garments may no longer fit. Garments may not longer meet the individual’s style preferences. Yet, such garments may be valued by others. However, many individuals will not consider selling, donating or leasing the garments because of the inconvenience and uncertainty that such transactions present.

Merchants want to increase sales. They would like consumers to purchase the merchant’s garments worn by other purchasers. Many merchants would be willing to provide a purchaser a reward if, in a verifiable manner, their wearing of a garment leads to additional sales of the garment by the merchant. Many consumers who have purchased or possess a garment from a merchant would be receptive to such a reward, and would be receptive to promoting the garment in consideration for the reward.

Many consumers would like and/or would be willing to share information about their possessions with others who are interested. Even if a consumer does not know another person, the consumer may be willing share such information, whether or not the sharing may lead to a reward.

Celebrities may be highly motivated to share information about their possessions with others who are interested. Not only will such sharing foster and enrich their fan base, but it may lead to appreciable rewards.

The foregoing problems and needs are not limited to clothing. Furniture, tools, vehicles, hobby and recreation items, and household items are nonlimiting examples of items in other product categories that an individual may own, possess, or seek, and may be subject to the same or similar problems or needs.

A system that helps individuals manage their possessions and share information about their possessions with others is needed. The system should be easy to setup and maintain. Past and new acquisitions should automatically be added, to facilitate setup and maintenance. Relegating a user to the unenviable task of manually entering all items would prevent widespread acceptance of such a system.

The invention is directed to overcoming one or more of the problems and solving one or more of the needs as set forth above.

### SUMMARY OF THE INVENTION

The claimed invention is similar to the invention claimed in co-pending allowed patent application no. 17248185, except that the invention claimed herein is triggered by video and sound data instead of image and voice data.

The claimed invention supplies, from a computing system on which virtual repositories are stored, to a first computing device, a result, that includes a link to a first item record of a second virtual repository, in response to a trigger and video or sound recognition. The independent claims are devoid of any commercial activity steps or limitations and recite steps that cannot be performed by a human. For example, recited steps of video and sound recognition, which cannot be performed by a human, are central to the respective claims.

Furthermore, the independent claims improve a computer system, by harnessing video or sound recognition to identify a repository and one or more item records. The inventions recited in the independent claims enable computers to perform a new function, namely automatically providing a link to a virtual repository record in response to a trigger and based upon video or sound recognition. This technology could enable a fan to automatically determine what a celebrity is wearing at an event, a portion of which is captured on video or recorded as sound, without burdening the celebrity with a personal request and without intruding on the celebrity’s privacy. In this example, the items worn by the celebrity at the event are identified by the first item record from the celebrity’s virtual repository. The trigger effectuates the provision of the link. The video or sound recognition allows identification of the celebrity and thus the celebrity’s virtual repository. The method uniquely enables absolute strangers to determine what another is wearing or using (without any direct communication or invasion of privacy). In sum, the subject method provides new functionality, which can only be accomplished using programmed networked computers. This method uses video or sound recognition in a new way.

A computer-implemented method of managing a virtual repository system according to principles of the invention entails a computing system storing a plurality of virtual repositories. Each virtual repository is associated with a user. Each virtual repository includes item records for items owned and used by a user. The computer system receives a selection of a first item record of a second virtual repository from a second computing device of a second user. The first item record corresponds to an item in use by the second user. The computing system also receives a first trigger from a first computing device of a first user. The first trigger requests first information associated with a virtual repository associated with an identified user and includes media information. The media information includes video and/or sound data associated to the second virtual repository, such as, for example, video and/or sound data for a video and/or sound that contains (i.e., shows or mentions) the first item record or is associated with a user using or appearing with the item corresponding to the first item record. The computing system performs video and/or sound recognition on the video data and identifies the second user. The computing system then sends results to the first computing device. The results include a link to the first item record of the second virtual repository, the first item record of the second virtual repository being responsive to the first trigger.

In one implementation, the second user is associated with an event. During the event, the second user uses items for which the second virtual repository includes item records. The first trigger includes a request for information associated with the event. For example, the first trigger includes broadcast information, including time data for appearance of a second user during a broadcast. Results are sent from the computing system to the first computing device. The results include an identification of the second user and an affiliate link for an item record of the second virtual repository.

In another implementation, the first trigger includes location information that identifies a location of the first user and/or the second user at a time at which the first trigger is received on the computing system. Te second user is in a determined vicinity of the location at that time. The results identify the second user and provide an affiliate link for an item record of the second virtual repository. The first user selects the affiliate link on the first computing device for which the second user is awarded (i.e., receives something of value, such as a commission).

In another implementation, the first trigger includes location information identifying a location of the first user at a first time at which the first trigger is received on the computing system. The results identify a plurality of users, excluding the first user, in a determined vicinity of the location at the first time. The results provide a link to a selected item record from each virtual repository for each user of the identified plurality of users.

In one embodiment, the computing system receives, via network communication, item records from a plurality of third party sources. The third party sources may include a remote merchant sales computing system. Also, item records may be derived from emailed invoices, receipts, and sales confirmations, and/or from a browser plugin that monitors online purchasing activity, and/or from manual user entry. The item records are records of items acquired by the user. The computing system merges the received item records (e.g., merged into a table, with each record including a plurality of fields) and stores the merged received item records in a cache (i.e., a storage where items are stored for reviewed). Data may be extracted from the received item records, which may entail identifying and storing data for the fields of each item record in a table. Data may include photographs. The computing system presents to the first user the merged received item records stored in the cache. The first user, via a computing device, validates the merged received item records stored in the cache as presented by the computing system. Then, the computing system associates the validated merged received item records stored in the cache with the first virtual repository and stores the validated merged received item records on a storage device. Affiliate links may be associated with validated merged received item records. In this manner, items acquired from a merchant or other sources may be added to a virtual repository after a user confirms that they should be added. Results may be presented as a link to an ordered table of data from item records and may include a link to navigable graphic representation of a virtual repository.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of exemplary networked computing devices on which a method and system according to principles of the invention may be implemented; and

FIG. 2 is a high level block diagram of exemplary components of a computing device which may be used to implement and use a method and system according to principles of the invention; and

FIG. 3 is a high level flow chart of exemplary steps of using a method and system according to principles of the invention; and

FIG. 4 is a high level flow chart of exemplary user administration steps for a method and system according to principles of the invention; and

FIG. 5 is a high level flow chart of exemplary steps for creating a new virtual repository for a method and system according to principles of the invention; and

FIG. 6 is a high level flow chart of exemplary steps for managing items in a virtual repository for a method and system according to principles of the invention; and

FIG. 7 is a high level flow chart of exemplary steps for performing actions relating to items in a virtual repository for a method and system according to principles of the invention; and

FIG. 8 is a high level flow chart of exemplary steps for adding items in a virtual repository for a method and system according to principles of the invention; and

FIG. 9 conceptually illustrates an exemplary user device on which a method and system according to principles of the invention may be used; and

FIG. 10 conceptually illustrates an exemplary user interface on a user device on which a method and system according to principles of the invention may be used; and

FIG. 11 conceptually illustrates an exemplary user interface on a user device on which a method and system according to principles of the invention may be used; and

FIG. 12 conceptually illustrates an exemplary virtual display for a method and system according to principles of the invention; and

FIG. 13 is a high level flow chart that conceptually illustrates steps of an exemplary method of populating a virtual repository with item data according to principles of the invention; and

FIG. 14 is a high level data model that conceptually illustrates exemplary data for a virtual repository with item data according to principles of the invention; and

FIG. 15 is a high level flow chart of steps of determining product data, from a transaction, for use in a virtual repository according to principles of the invention; and

FIG. 16 is a high level flow chart of steps of an exemplary triggering process for use with a virtual repository according to principles of the invention; and

FIG. 17 conceptually illustrates a device (e.g., smart phone) with a displayed media (e.g., video or photo) showing a person and a control for initiating video and/or sound recognition to identify the person for use with a virtual repository according to principles of the invention; and

FIG. 18 conceptually illustrates an exemplary user device on which a trigger control is displayed according to principles of the invention may be used; and

FIG. 19 conceptually illustrates components and steps of an exemplary method of media capture, fingerprinting and matching according to principles of the invention may be used.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

The claimed invention is similar to the invention claimed in co-pending allowed patent application no. 17248185, except that the invention claimed herein is triggered by video and sound data instead of image and voice data.

An exemplary virtual repository method and system with robust item management automatically derives item data from accessed current and past transactions. The system interfaces with merchant systems to receive current and archived transaction data, scans emails for current and past transaction data, monitors browser data for online transaction data, and accepts manual input. The system establishes a communication channel with each remote disparate source. The system executes program instructions to harvest data from each local source. Data obtained from all sources is filtered, collated and stored in a cache, for user review, modification and approval, whereupon the data populates a virtual repository. The resulting virtual repository accurately reflects a user’s real world acquisitions within a user-defined category, which facilitates managing (e.g., using, sharing, disposing of) and capitalizing on (e.g., selling, leasing, promoting, donating) acquired items.

An implementation of the present invention may be embodied in hardware and/or in software (including firmware, resident software, micro-code, etc.). Furthermore, the present invention may take the form of one or more computer program products on one or more computer-usable or computer-readable storage media having computer-usable or computer-readable program code embodied in the media for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific non-limiting examples (a non-exhaustive list) of a computer-readable medium include random access memory (RAM), a read-only memory (ROM), an erasable programmable read-only memory (EPROM or Flash memory), a hard disk drive, a solid state drive, and optical discs.

Computer program code or “code” for carrying out operations (e.g., steps) according to the present invention may be written in any programming language compatible with the corresponding computing devices and operating systems. Software embodiments of the present invention do not depend on implementation with a particular programming language.

The computer program code may be provided to a processor of a general-purpose computer, special purpose computer, or other programmable computing apparatus (e.g., a phone, personal digital assistant, tablet, laptop, personal computer, or computer server) as instructions, such that the instructions, which execute via the processor of the computer or other programmable data processing apparatus, create means for implementing the functions described herein. The computer code may be stored in a computer-readable memory that can direct a computer or other programmable data processing apparatus to function in a particular manner, such that the instructions stored in the computer-readable memory produce an article of manufacture including instruction means which implement the functions and perform the steps specified in the illustrations and described herein.

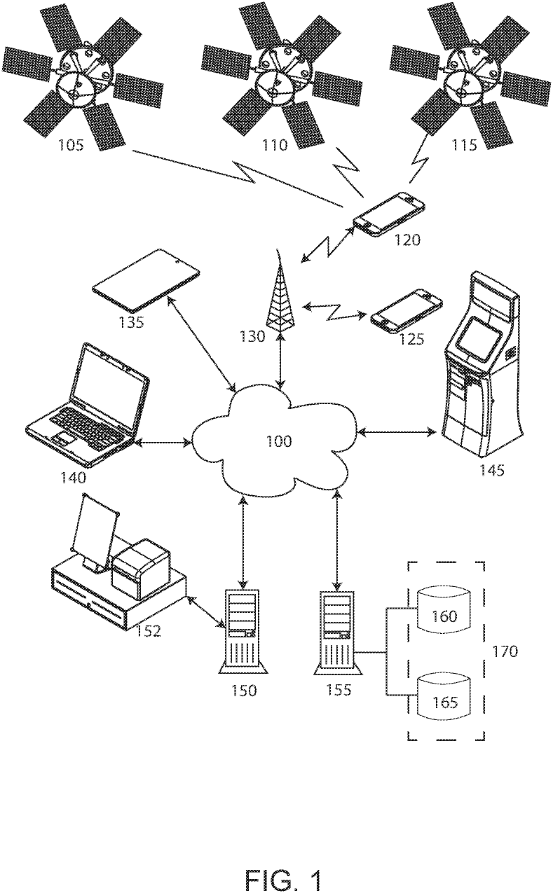

Referring now to FIG. 1, a high level block diagram of hardware components of a system according to principle of the invention is conceptually illustrated. Consistent with the present invention, users of the system use computing devices, such as a smartphones 120, 125, tablets 135, laptop computers 140, personal computers or a kiosk 145, desktop computers or servers 150, communicating in a wireless or wired mode via the Internet 100. The computing devices (i.e., clients or client devices) are equipped with software for inputting and displaying information in accordance with the methodologies described herein. Such software may comprise a web browser, a client application and/or a mobile device app. Some of the computing devices 120, 125 may be equipped with cellular wireless communication modules providing internet access via wireless cellular communication infrastructure 130. Some of the devices may be used by end users for creating and managing virtual repositories, while other devices (e.g., point of sale device 152 and server 150) may be used by merchants to supply data and provide rewards.

A virtual repository is an aggregation of data pertaining to items, which may be presented to a user in an easy to manage graphical user interface. The items of a virtual repository may fall within a category, such as clothing. The virtual repository may be shared by a user, allowing other users to access the virtual repository for viewing and other allowed actions (e.g., commenting and click-through purchasing). Specific items within a virtual repository may be shared, allowing other users to access data for those items for viewing and other allowed actions (e.g., commenting and click-through purchasing). The graphical user interface may present in data in lists, tables, navigable 2D or 3D models, or augmented reality displays. A user may create a plurality of virtual repositories, assign items to one or more virtual repositories. Advantageously, a system and method according to principles of the invention collates, in a cache (temporary storage), data received and/or extracted from multiple independent sources (described below). A user may review and verify the cached data, modify or delete the cached data, and assign it to one or more virtual repositories. A system and method according to principles of the invention also collates manual entries into the virtual repository.

Referring still to FIG. 1, one or more computers such as server 155 includes or has access to a database management system for managing product data. One or more databases may contain aggregations of data records or files, pertaining to virtual repositories. A communications network interconnects the server 155, directly or indirectly through one or more additional computers, with the Internet 100. Interconnected computers communicate with each other through mechanisms such as interprocess communication, remote procedure call, distributed object interfaces, and various other program interfaces. The databases may be stored on one or more storage devices 160, 165, collectively the data storage 170. The database may be queried using various database access means such as SQL (Structured Query Language), a standard language for interacting with a database; Open Database Connectivity (ODBC), an open standard API for accessing a database; DCOM (Distributed Component Object Model), a set of Microsoft tools and program interfaces for enabling client program objects to request services from server program objects on another networked computer; Common Object Request Broker Architecture (CORBA), an architecture and specification which allows programs at different locations and developed by different vendors to interact in a network through an interface broker. Illustratively, the clients 120, 125, 135-150 may execute one or more processes that interact server 155 to supply, access and manage data stored on the data storage 170. Each request received by the server 155 may be submitted as a TCP/IP communication packet including an IP address and socket number. In response to valid requests, the server 155 may provide data from the data storage 170, without compromising the integrity of the database.

In certain embodiments of a system and methodology according to the principles of the invention, a user’s location may be specified. Location may be user input or automatically determined using GPS data, IP trace or triangulation information. Some of the computing devices may be equipped with Global Positioning System (“GPS”) receivers for receiving signals from GPS satellites 105-115 to determine location of the device.

Certain clients 120-150 may not have access to a GPS service (for example, they may lack hardware necessary to support such a service); consequently, such GPS information may not be available for all clients 120-150. Also, certain GPS services do not operate or do not operate reliably in certain locations, such as indoors or other enclosed spaces. Thus, even if a client 120-150 does have the necessary hardware and software to support a GPS service, occasionally GPS information from the GPS service may not be available to a particular client 120-150.

IP trace information may include the public IP address of the client 120-150 and the set of IP addresses that data packets sent from the client 120-150 pass through to reach server 150. The public IP address of the client 120-150 may be determined by gathering the source IP address from the server socket receiving the client 120-150 connection. The list of hops through which the data packets sent from the client 120-150 go through may be determined by sending adaptive TTL (time to live) UDP packets to server 150 from the client 120-150. In order to determine if the client 120-150 is being an IP proxy, server 150 may correlate the list of hops with the public IP address of the client 120-150. In this way, server 150 may effectively discover the real public IP address of the client 120-150. The real public IP address of the client 120-150 is then matched against a database of Internet Service Providers (ISPs) which returns the probable address of the originating client 120-150 message. This probable address of the originating client 120-150 message may then be translated to a set of longitude and latitude coordinates.

Triangulation information for a client 120-150 may include a list of public Wi-Fi access points surrounding the client 120-150 as well as the signal strength of each Wi-Fi access point accessible by the client 120-150. The list of surrounding Wi-Fi access points, and their signal strength, may be formatted and correlated with a database of public Wi-Fi access points by server 150 to determine a probable set of longitude and latitude coordinates for the client 120-150. The database of public Wi-Fi access points employed by server 150 may be updated over time to reflect new information about available Wi-Fi access points.

The invention is not dependent upon location information. Certain implementations of the invention may not take location into consideration. In implementations that take location into consideration, certain types of location data may be more accurate or reliable than others. GPS information is more accurate and indicative of the correct physical location of a client 120-150; however, as explained above, GPS information for a particular client 120-150 may not always be available. Triangulation information, while not as accurate and reliable in identifying the correct physical location of a client 120-150 as GPS information, is more accurate and reliable than IP trace information. However, triangulation information also may not always be available, e.g., the client 120-150 may not be able to detect any nearby recognizable Wi-Fi access points. Additionally, while IP trace information is less accurate than either GPS information or triangulation information in determining the correct location of a client 120-150, it is always obtainable if the client 120-150 can communicate to server 150 over the Internet.

Additionally, a user may input location (e.g., an address) for a device, such as a personal computer, laptop 140 or tablet 135, that may not be equipped with a GPS receiver. For a device, such as a kiosk 145, at a fixed location, the location of the device may be known and associated with a unique identifier (e.g., MAC address) for the device.

The term “service provider” is used herein to mean any entity that provides a service using a system or methodology according to principles of the invention. The service provider may be, for example, an online service provider with a web-accessible system that receives, sends, stores and processes data and instructions for managing and sharing a virtual repository according to principles of the invention. The terms “consumer” or “client” is used herein to mean any individual or entity that uses the service provider’s services to manage and share a virtual repository, whether for free or in exchange for compensation. The term “user” or “end user” is used herein to mean any individual or entity that uses the system for managing and sharing a virtual repository according to principles of the invention. In many cases, a user is a consumer. However, in some cases, a consumer may have an assistant or agent use the system on the consumer’s behalf. A merchant is a commercial party (e.g., a vendor of goods or services, a credit card processor or another service provider), who may access the system for performing such actions as supplying data and rewarding consumers. A merchant may also be a consumer, client, and end user. Likewise, a consumer, client, and end user may also be a merchant.

Using the computing device 120-150 and client software (“client”) such as a browser or app, a user may create, manage and share a virtual repository according to principles of the invention.

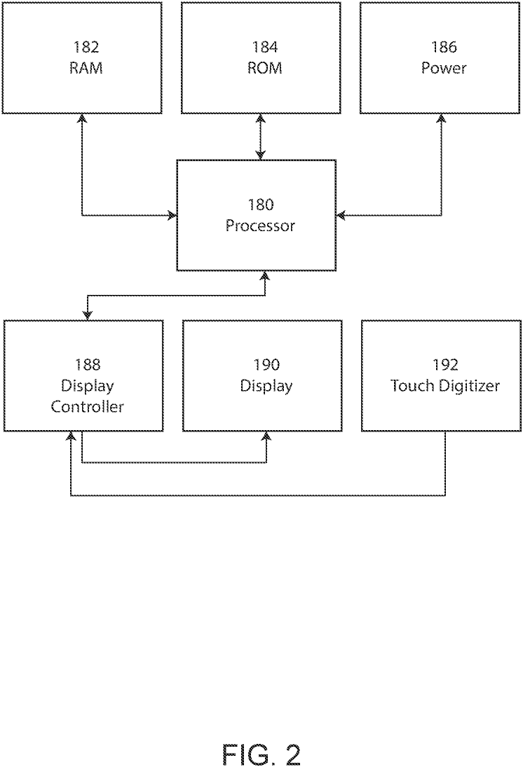

Each exemplary computing device for use in accordance with principles of the invention includes a processor, memory, power supply, display, storage and user input device. Other components include a communication bus, and network communication components, such as cellular, WiFi and LAN. By way of example, and not limitaion, with reference to FIG. 2, a mobile device such as a smartphone 120, 125 may include one or more processing units (CPU’s) 200, memory such as RAM 205 and ROM 210, and a power supply 215. Additionally, the device 120 may include a display controller 220, a display 225 and a touch digitizer 230. These may comprise merely a few of the components of the mobile device 120. Various components may be implemented in hardware, software, or a combination of both hardware and software, including one or more signal processing and/or application specific integrated circuits. The touch digitizer 230 comprises a touchscreen, an electronic visual display that the user can control through simple or multi-touch gestures by touching the screen with a special stylus/pen and-or one or more fingers. The touchscreen enables the user to interact directly with what is displayed, rather than using a mouse, touchpad, or any other intermediate device (other than a stylus, which is optional for most modern touchscreens). The touch digitizer 230 further comprises a transparent overlay covering the visual display. The overlay senses the touch of one or more fingers or a stylus. In response to a touch, the overlay produces a change in electrical properties (e.g., a change in current, voltage, capacitance or resistance). The touch digitizer interprets the commands that the changed electrical properties represent and communicates the commands to the appropriate applications. The touch digitizer 230 further comprises a display controller that receives and/or sends electrical signals from and to the visual display and overlay. Visual output may include graphics, text, icons, video, and any combination thereof (collectively termed “graphics”). In some embodiments, some or all of the visual output may correspond to user-interface objects. The display controller (along with any associated modules and/or sets of instructions in memory) detect contact (and any movement or breaking of the contact) on the overlay and converts the detected contact into interaction with user-interface objects (e.g., one or more soft keys, icons, web pages or images) that are displayed on touch-sensitive display. In an exemplary embodiment, a point of contact between touch digitizer 230 and the user corresponds to a finger of the user. The visual display may comprise LCD (liquid crystal display) technology, LPD (light emitting polymer display) technology, or LED (light emitting diode) technology, although other display technologies may be used in other embodiments. The overlay and display controller of the touch digitizer 230 may detect contact and any movement or breaking thereof, including speed (magnitude), velocity (magnitude and direction), and/or an acceleration (a change in magnitude and/or direction) of the point of contact, using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display. These operations may be applied to single contacts (e.g., one finger contacts) or to multiple simultaneous contacts (e.g., “multitouch”/multiple finger contacts). Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

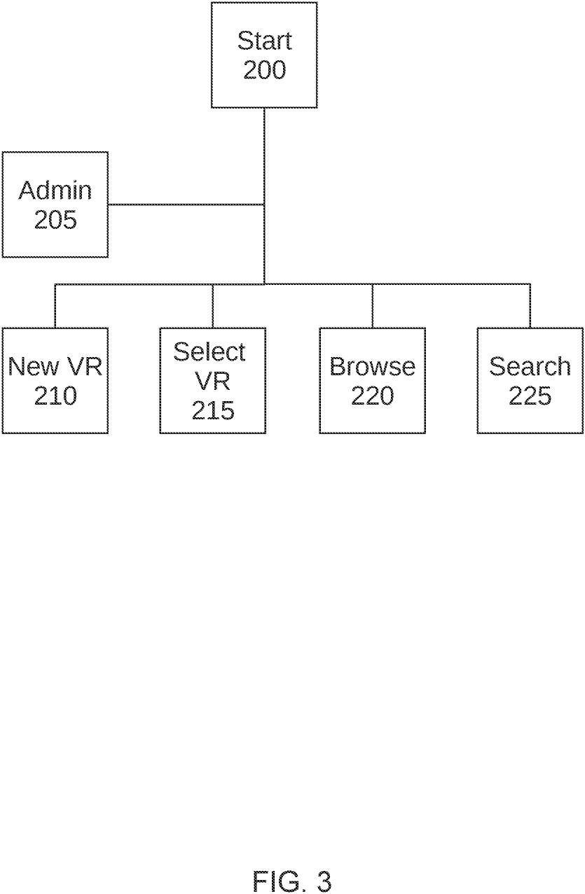

FIG. 3 provides a high level flow chart of exemplary steps of using a method and system according to principles of the invention. A user may start an application (i.e., software application) on a computing device, as in step 200. The application provides access to functions, including administrative functions 205, functions for creating a new virtual repository as in step 210, functions for selecting an existing virtual repository as in step 215, functions for browsing the user’s and/or other users’ shared virtual repositories as in step 220, and functions for searching for other users’ shared virtual repositories as in step 225. A user may select a function

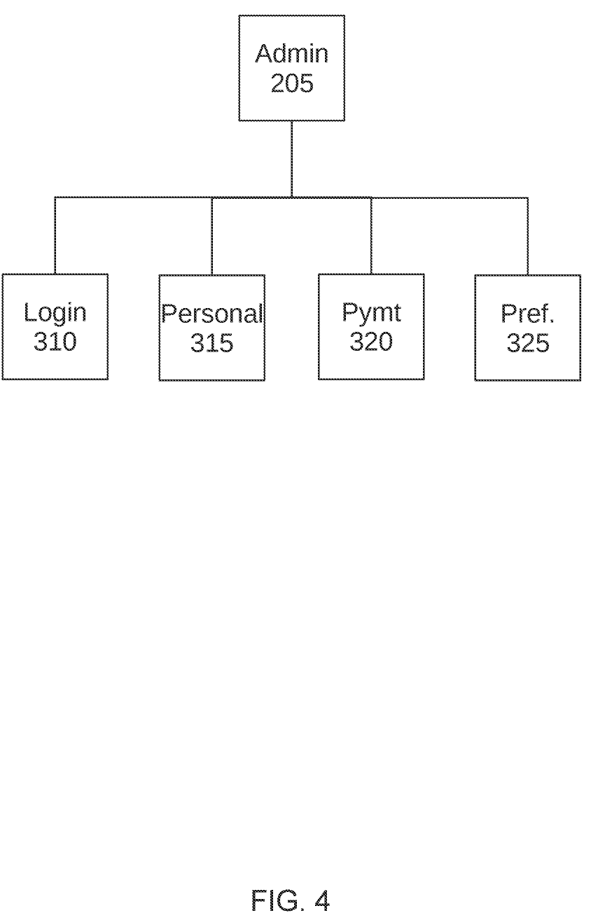

With reference to FIG. 4, administration functions 205 include functions for setting information and preferences for a user. A user may establish a login, which may include a user name and password, as in step 310. For multifactor authentication, a user may also provide a smartphone number and/or email address. A user may input personal information, such as name, address, screen name, telephone number, email address, information regarding the user’s profession, a photograph of the user, and links to other information about the user, as in step 315. A user may input payment information for any commercial transactions performed using the system, as is step 320. The information may include card information, a billing address, and a default shipping address, The user may also specify preferences, including security preferences related to privacy of the user’s virtual repositories, display settings, notification settings, and sound settings, as in step 325.

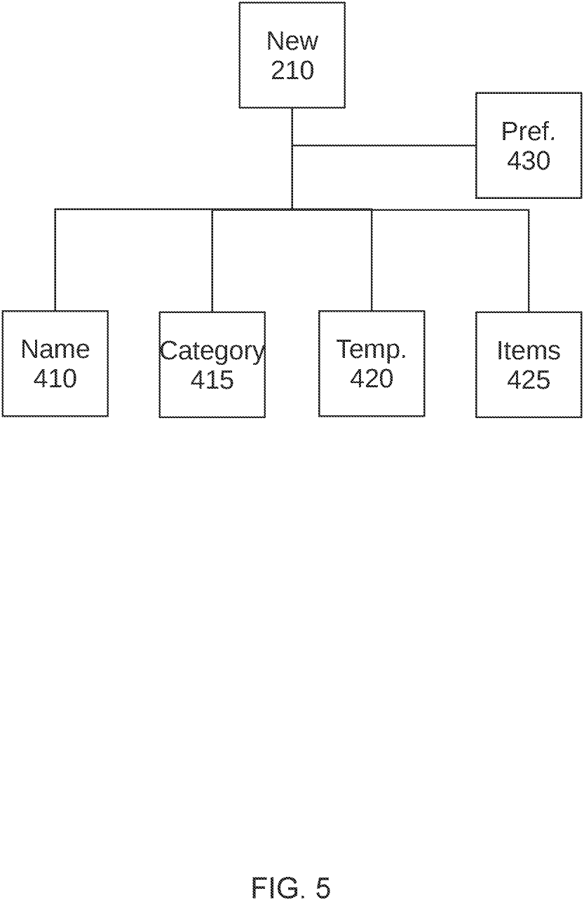

FIG. 5 is a high level flow chart of exemplary steps for creating a new virtual repository for a method and system according to principles of the invention, as in step 210. A user may assign a name for the new virtual repository, as in step 410. A user may assign a category for the new virtual repository, as in step 415. A user may select a template for the presentation (display) of the virtual repository, as in step 420. Available templates may, by way of example, include a list, side-to-side scrolling presentations, top-to-bottom scrolling presentations, navigable 3D models of a space such as a closet, and even augmented reality displays of the user’s actual closet. The scrolling presentations may include multiple levels (as discussed below), allowing a user to separately scroll through various subcategories of items within a virtual repository. By way of example, a three level scrolling display may allow a user to separately scroll through the user’s shirts, pants and shoes. As another example, an augmented reality presentation may allow a user to walk through a closet while aiming a smartphone at the items in the closet, and receive information about each item on the display. A user may setup more than one template, for the user to select from when using the application.

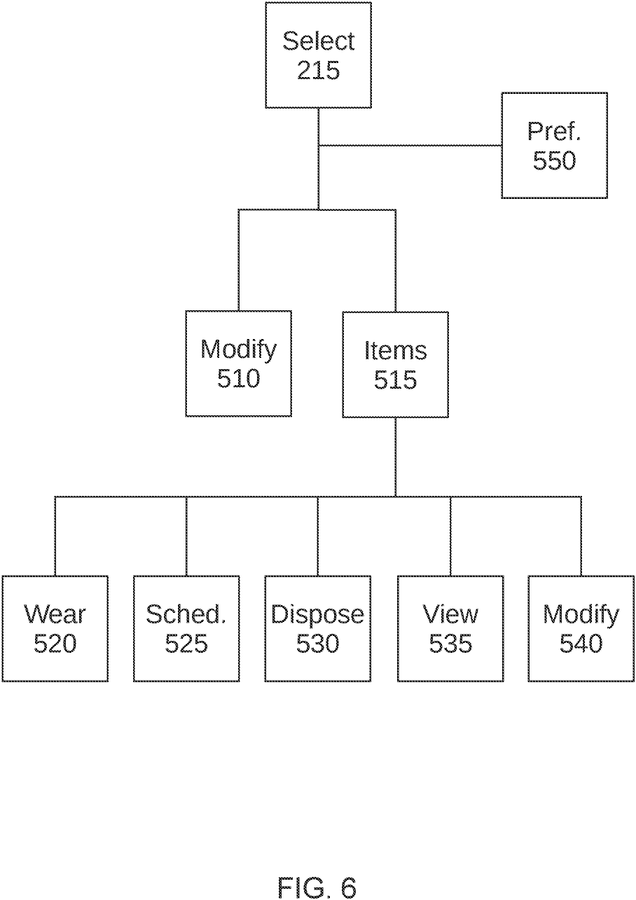

FIG. 6 is a high level flow chart of exemplary steps for managing a virtual repository for a method and system according to principles of the invention, as in step 215. Upon selecting a previously created virtual repository, the user may manage (e.g., review and edit) preferences as in step 550, modify the virtual repository’s name or category as in step 510 or select or modify items, as in step 515. In the case of clothing items, an item may be selected for wearing, as in step 520. Alternatively, an item may be scheduled for wearing on a scheduled date and time, as in step 525. An item may be disposed of (e.g., sold, discarded, donated or given away) as in step 530. An item may be viewed, as in step 535. Viewing an item may display information about the item, including use-related information.

If a user enters into the system information about wearing (or otherwise using) each item, then the system may present a history and/or frequency of use. A system and method according to principles of the invention may save all entered dates of use, as in step 520. For example, a user may enter each date on which the user wore a particular garment. From such dates, the system may determine the last time an item was used and a frequency of use. Date of use data may alert a user to unused, infrequently use and frequently used items. A system according to principles of the invention may notify a user of items that the user did not use in a determined number of days (e.g., 100, 180 or 365 days). Knowing specific dates of use may also help a user determine if the same item should be used (e.g., worn) again. For example, a user may want to avoid wearing the same suit on a follow-up job interview, or the same dress at an upcoming event or party that will be attended by some folks who attended a previous party.

An item may be modified (i.e., stored information pertaining to the product may be modified) as in step 540. Modification may include adding comments about comfort, fit, and accessories. For example, a user may note that a garment fits loosely or tightly, or is best worn with a particular accessory. Some such notes may be accessible only by the user, and other notes may be shared with other users.

A system and method according to principles of the invention may incentivize users to input use dates for an item. Such use may be input by simply selecting the item and selecting a current use button or by selecting the item and providing a verbal command, or by entering a date. As described above, a user’s location may be tracked through a device, such as a smartphone. Inputting use dates helps a user track which items are used and when, which, as discussed above, is beneficial. Additionally, use information may lead to rewards. Shared items are visible to other users. A worn item may be a shared item. Other users may search for an item worn by a user at an event, or on a certain date and time, and/or at a specific location. Upon finding the item, such other users may click through the item to purchase it from a merchant. Through an affiliate program, the merchant may reward the user who shared the item. Such reward may be a payment to an account of the user. To maximize such payments, users will want to regularly input use dates, share items and wear items well.

Disposing of an item, as in step 530, may entail selling, renting, donating, gifting or discarding an item, and thereupon removing the item from the virtual repository, or, in the case of renting, marking the item as unavailable during the rental term. These functions enable a user to capitalize on items.

For example, using the information about an item in the virtual repository, a selling price or auction bidding terms, and one or more current photographs of the item, the item may be marked for sale. Upon being marked for sale, the item is shared and may be searched and viewed by all other users of the system. Such other users may purchase or, in the case of an auction, bid on purchasing the item.

Similarly, a user may mark an item for donation, which may present a list of willing charitable organizations in the vicinity of the user who would be glad to receive the item. The user may select an organization from the list. A record of each completed donation may be generated for tax deduction purposes.

An item may be marked for renting. For example, a user may own a ball or bridal gown, tuxedo, a costume, skiing apparel, a wetsuit, or some other expensive and infrequently used item. The user may be receptive to renting the item to other users. By marking an item for rental, that item is searchable by all other users of the system. Such other users may rent the item.

By providing the sale, donation and rental functions, a system according to principles of the invention facilitates capitalizing on items. Items that a user does not use, or infrequently uses, may be sold, rented or donated. In each case, the user receives a benefit. In the case of sales or rentals, the user receives monetary compensation. In the case of donation, a tax reduction may be earned. In each case, the user gains the knowledge that an item has not gone to waste, but rather is put into good use.

While other systems for selling, leasing and donating items may exist, none is tied to an existing virtual repository. By tying the such systems to a virtual repository, a system and method in accordance with principles of the invention facilitates identifying unused or infrequently used items, and also facilitates posting such items for sale or rental, or donating such items to a worthy charity.

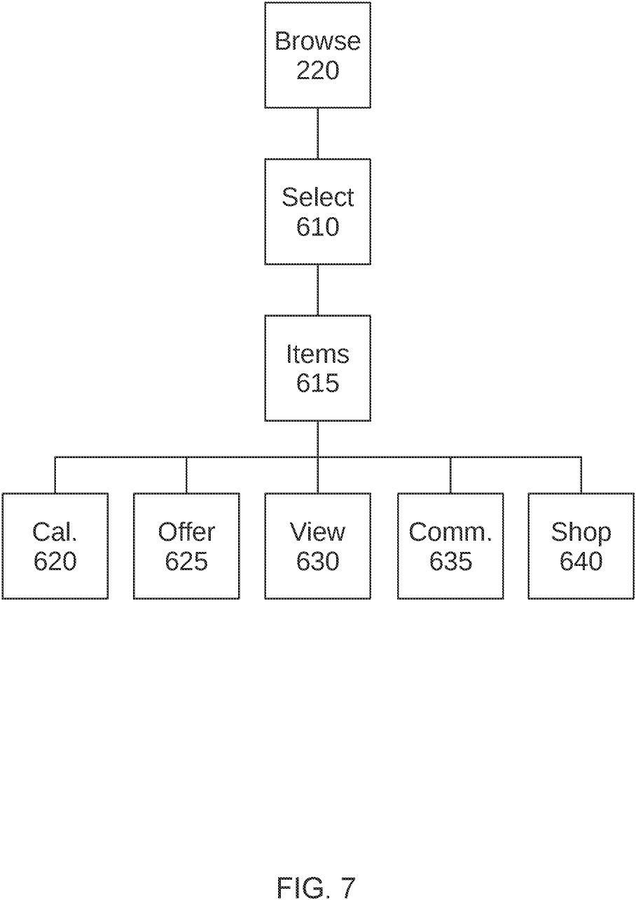

FIG. 7 provides a high level flow chart of exemplary steps for performing actions relating to items in a virtual repository for a method and system according to principles of the invention. In particular a user may browse items in the user’s virtual repositories, as in step 220. A user may select a virtual repository from a list of the user’s virtual repositories, as in step 610. A user then may view and select an item in the virtual repository, as in step 615. The user may calendar the item, as in step 620. By calendaring the item, the user indicates a date on which the user intends to use (e.g., wear) the item. A user my offer to sell or rent the item, as in step 625. The terms of the sale or rental may be set by the user, within determined parameters of the system. The use may view the items, as in step 630. A photograph of each item may be stored as item data, as described above. The photograph may be user supplied or obtained from a vendor’s online posting for the product. A user may enter comments about an item, as in step 635. For example, a user may describe the comfort, fit or feel of an item, or describe an event at which the item was used (e.g., worn), or enter other information (e.g., an endorsement) relating to the product. A user may locate the item in a retail establishment, as in step 640. By locating the item in an online or brick and mortar retailer, the user may shop for other similar or matching items and accessories.

The flow chart of FIG. 7 also applies to browsing shared virtual repositories and items of other users. A list of virtual repositories may be generated by a search from a search engine or from a directory. A user may search for a particular user’s virtual repository, a celebrity’s virtual repository, a virtual repository that contains certain items. A user may navigate through categories and subcategories of a directory to generate a list of repositories. Filters may be provided to narrow the list. A user may select a repository as in step 610. A list of shared items in the repository is presented, as in step 615. A user may select shared calendar information for a selected item, as in step 620. Such information reveals when the user used (e.g., wore) the item. A user may offer to purchase the item an item from such a list, as in step 610. A user may simply view the item, as in step 630. A user may enter comments about the shared item, as in step 635. A user may shop for the selected item, as in step 640. Purchase of the selected item may lead to a reward (e.g., compensation) for the user who shared the item.

An affiliate program may track click-throughs to merchant sites and enable payment of commissions to a user who shared the item and from which the purchase originated. To enable affiliate compensation, an affiliate link may be associated with each shared item. The affiliate link carries information that identifies the source of the click-through so commissions can be accurately payable. In one embodiment when an affiliate link is clicked, a cookie is deposited on the user’s computing device. When a user completes a sale on the merchant’s site, the merchant checks to see whether their cookie is present on the user’s computing device. If it is, the merchant can access information from the cookie about the user that shared the item and generated the sale lead, and can then attribute the sales commission to that sharing user. Merchants can set the commission structure and cookie lifetime via the affiliate network. For instance, a merchant may decide to assign a cookie lifetime of 60 days, which means any sale made on the merchant’s site by a user within 60 days of the user first visiting the merchant’s site via the sharing user’s repository, is commission-generating for the sharing user.

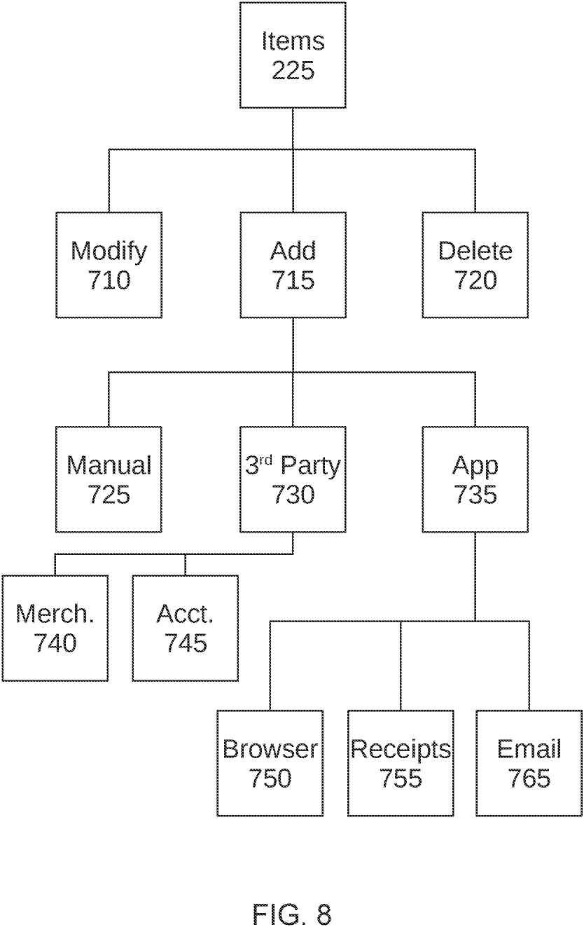

FIG. 8 is a high level flow chart of exemplary steps for modifying, adding and deleting items (step 225) in a virtual repository for a method and system according to principles of the invention. Selected items may be modified as in step 710. Modification may include editing entered content and photographs. Selected items may be deleted as in step 720. Items may be deleted automatically if sold or donated using the system. Items may also be deleted manually at any time by the user who owns the virtual repository.

Items may be added manually, by user input, as in step 725. Manual addition may entail typed user input, uploaded files, scanned documents, optical character recognition of documents, and verbal commands.

Items may be added from third party sources, as in step 730. Third party sources may include purchase histories from accounts accessible online. Such accounts may include online retailer and marketplace accounts (e.g., online Walmart, Amazon and Macy’s accounts). Another third party source may be merchants’ point of sale system data. Participating merchants may communicate purchase data for participating users to the system via an application programming interface. The purchase data may be pushed by a merchant from point of sale transactions by the user. Alternatively, purchase data may be pulled by a user from a merchant’s point of sale system, via an application programming interface. Even purchase data for purchases at most brick and mortar establishments are stored on merchant servers connected to their point of sale systems.

Items may be added via applications (e.g., plugins and add-ons) that monitor a user’s browser activity and emails for purchase data, as in step 735. A browser plugin may track online purchasing activity, as in step 750. Online purchases are detected via the website and user selections, including online shopping cart activity. Emails, as in step 765, may provide order confirmations, many of which may contain a hyperlink to an account on a remote server where details of the transaction are provided. Accessing a remote account may require a login (e.g., user name and password), which the user can supply to the system. Emails may also provide detailed receipts, as in step 755. Receipts may also be uploaded by a user for processing. Such processing may entail optical character recognition and determining purchase data.

Data from sources other than manual entry is stored in a cache or temporary storage until verified by a user. The cached data may be displayed to a user in a list comprised of records (rows) and fields (columns). Thus, a system and method according to principles of the invention merges (i.e., collates) data extracted for various sources, including remote (e.g., merchant systems) and local sources (e.g., mined emails) into a cached list for possible addition to a virtual repository. The user may verify each record for entry into the virtual repository. Data for a record may be modified by a user before verification. Records may be deleted by a user. For example, a user may determine that a record does not belong in the virtual repository, such as if the purchase is a gift for a friend.

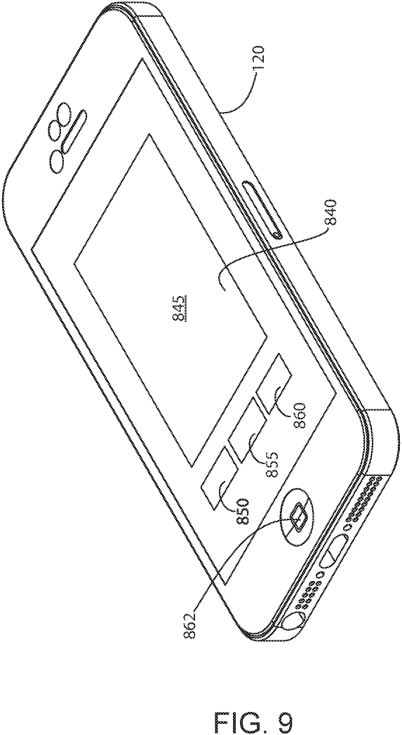

FIG. 9 conceptually illustrates an exemplary user device 120 on which a method and system according to principles of the invention may be used. A graphical user interface 840 may be presented on a display 845. The user interface may present information and graphics pertaining to virtual repositories, items and user accounts. Various user-selectable controls 850-860 may be displayed for user control. A microphone 862 may accept voice commands 862. Modern operating systems include a voice-user interface that makes spoken human interaction with a device possible, using speech recognition to understand spoken commands and typically text to speech to play an audible reply.

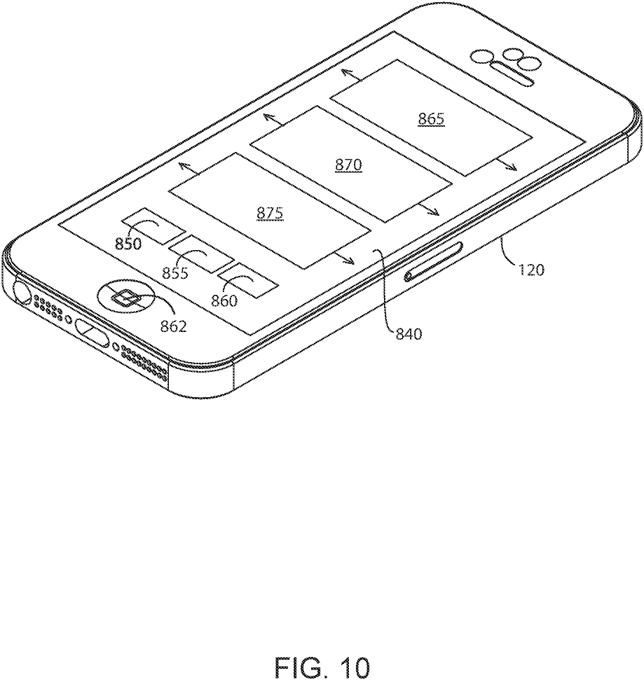

FIG. 10 conceptually illustrates another exemplary user interface on the user device 120 on which a method and system according to principles of the invention may be used. This graphical user interface may include three levels 865-875 of display. Different items may be displayed on each level. By way of example, data and images pertaining to shirts may be displayed on the top level 865; data and images pertaining to pants may be displayed on the middle level 870; and data and images pertaining to shoes may be displayed on the bottom level 875. The different levels may represent different virtual repositories, such as a repository for shirts, another repository for pants, and another repository for shoes. Alternatively, the different levels may represent different categories of items within a particular virtual repository.

A user assigns the number of levels and the virtual repository, category, or specific items to be displayed at each level. Such assignment may be made by a command or touch gesture relating to the level. For example, a swipe upwardly on a level or a voice command (“assign levels”) may command the system that the user wishes to assign a virtual repository, category, or specific items to be displayed at the level. Upon receiving the command, the system presents controls for making the assignments.

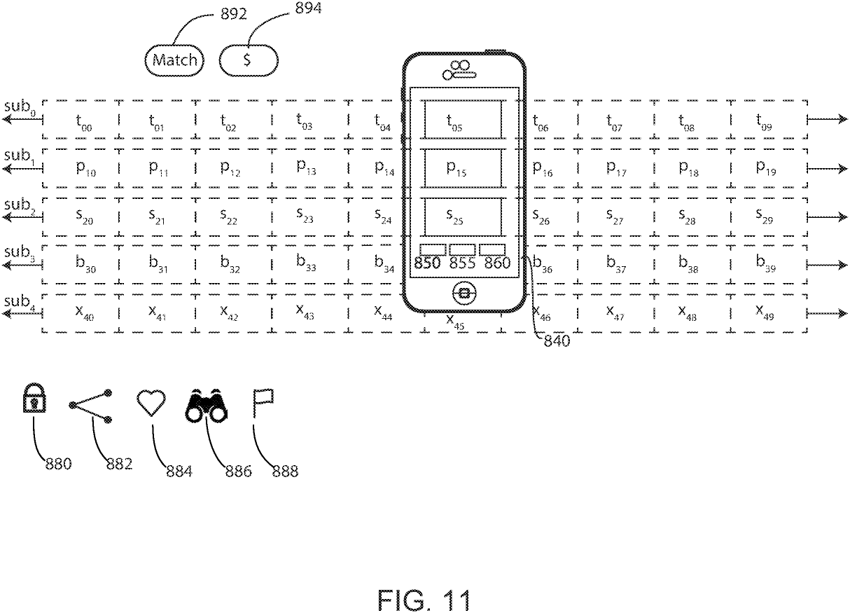

With reference to FIG. 11, each level of the user interface may present data pertaining to an item, which may include a pictogram of the item. Swiping to the left may load for display the next item to the left in a continuous list. The list is continuous, because swiping past the beginning presents the end of the list, and swiping past the end of the list presents the beginning of the list. Thus, the list behaves like a reel. Swiping to the right may load the next item to the right in the continuous list. In the displayed exemplary embodiment, the top list includes data for items t₀₀ through t₀₀₉, the middle list includes data for items p₀₀ through p₀₀₉; and the bottom list includes data for items s₀₀ through s₀₀₉. Selectable icons for various commands may be presented, including, by way of example and not limitation, a lock icon 880 for security options, a share icon 882 for sending a link or a pictogram to an intended recipient, a heart icon 884 for rating the item, a binocular icon 886 for focusing on the item (i.e., obtaining details) and a flag icon 888 to mark the item for further review. A match control 892 may command the system to match items, such as men’s dress shirts, with dress pants and dress shoes from the available items. A $ control 894 may invoke financial functions, including selling, renting and purchasing functions. These are non-limiting examples of controls and logic of a user interface.

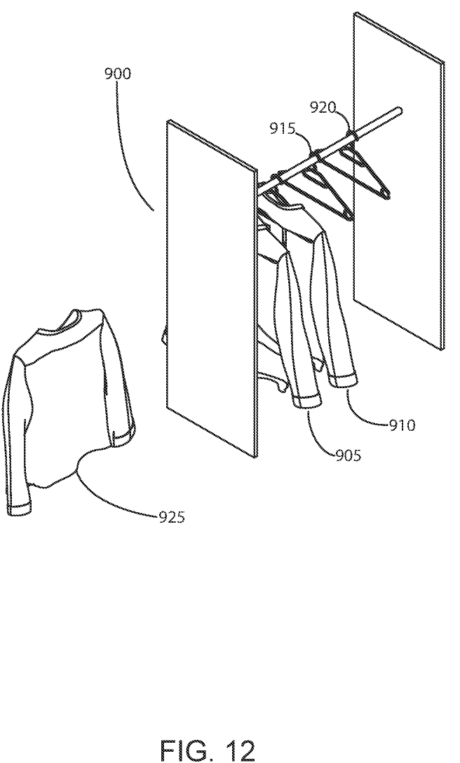

FIG. 12 conceptually illustrates an exemplary 3D virtual display for a method and system according to principles of the invention. The exemplary virtual display resembles a closet 900 containing shirts 905, 910, 925. The closet includes hangers 915, 920 on a hanger rod. An empty hangar may represent a shirt that has been removed and not available for use, such as a shirt sent out for dry cleaning. Mousing over a shirt or hanger displays details about the item and a photo or pictogram. Clicking on the details displays editable details and controls for the item. Removing a shirt from the closet, such as shirt 925, may indicate that the shirt is or will be worn. Mousing over the removed shirt displays details about the item and a photo or pictogram. Clicking on the details displays editable details and controls for the item. The shirts may be colored to represent the color of the actual item. The shirt icons may come in several styles (e.g., polo, henley, t-shirt, dress shirt, etc...). The angle of viewing may be changed by touch gestures or voice commands.

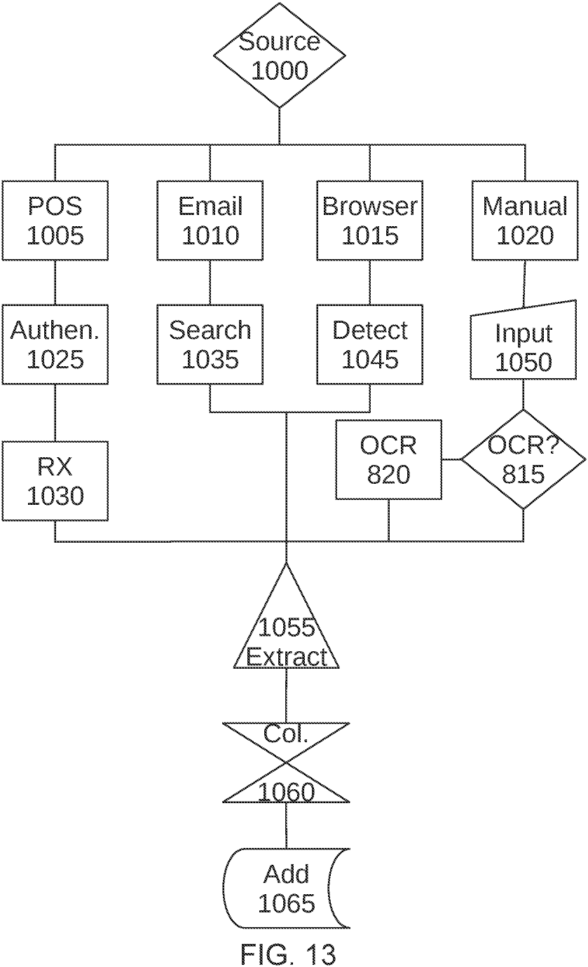

FIG. 13 provides a high level flow chart that conceptually illustrates steps of an exemplary method of populating a virtual repository with item data according to principles of the invention. If a source is available for supplying data as in step 1000, then steps are undertaken to extract and collate the data. Data from a point of sale transaction may be supplied through a participating merchant’s server, as in step 1005. As in step 1025, in the case of pushed data the merchant’s server may authenticate the merchant and user for which the data is being supplied. Such authentication may comprise a unique login and user id. In the case of pulled data, the virtual repository system may provide authentication to the merchant’s server. Then, the user’s data is received, as in step 1030. After receipt, the relevant fields of data are extracted, as in step 1055 and the extracted data is collated into a record, as in step 1060. Thereafter, the record may be cached for user review, editing and validation before being incorporated into a virtual repository as in step 1065.

Similarly, data may be obtained through emails, as in step 1010. Emails may be periodically searched for receipts, order confirmations and the like. Data may be extracted from receipts attached to emails as in step 1055. Some emails may provide links to follow for details about an order. The system may follow the links, using the user’s login information for the account on the merchant’s system, to access the purchase data and extract the relevant data, as in step 1055. Again, the extracted data is collated into a record, as in step 1060. Thereafter, the record may be cached for user review, editing and validation before being incorporated into a virtual repository as in step 1065.

Similarly, data may be obtained from browser activity 1015. A browser plugin or add-on may monitor for purchase activity by identifying online shopping cart features or purchase controls, as in step 1045. Data may be extracted from scripts for displayed screens, as in step 1055. Again, the extracted data is collated into a record, as in step 1060. Thereafter, the record may be cached for user review, editing and validation before being incorporated into a virtual repository as in step 1065. As such browser activity may also result in an emailed receipt or confirmation order, care is taken to prevent duplicate entries to a virtual repository.

Data may also be obtained by manual entry 1020. Using an available input device, a user may enter and/or upload data, as in step 1050. If an image of a scanned or photographed receipt or purchase order is uploaded, optical character recognition may convert the image to text for extraction, as in steps 815 and 820. Data may be extracted from the processed upload, as in step 1055. Again, the extracted data is collated into a record, as in step 1060. Thereafter, the record may be cached for user review, editing and validation before being incorporated into a virtual repository as in step 1065.

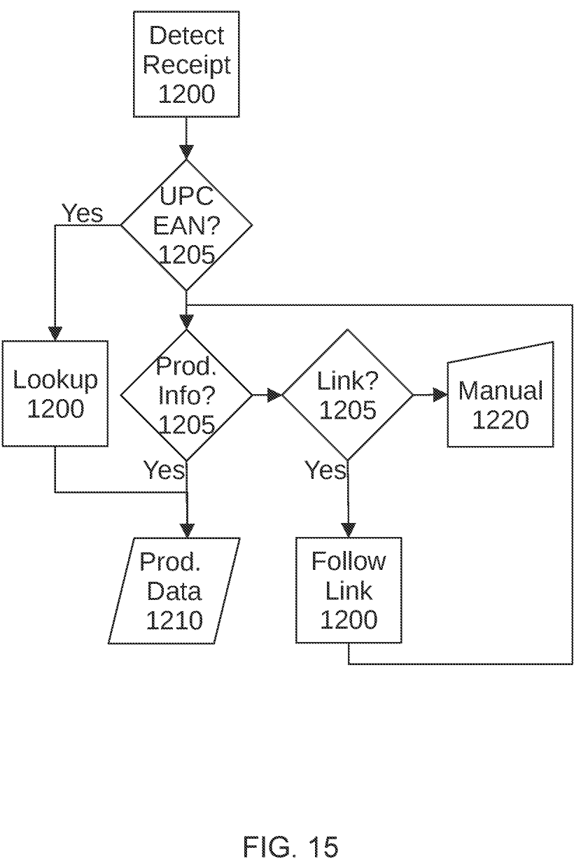

FIG. 15 conceptually illustrates steps of processing receipts to extract relevant data for collation according to principles of the invention. A detected receipt 1200 may be a receipt attached to an email, an order confirmation in an email, or an uploaded receipt. The receipt may be a text document, or an image of a receipt, such as a scanned or photographed receipt. In the latter case, optical character recognition may be performed to make the data system readable. In step 1205 the receipt is reviewed for a standard industry code, such as a UPC or EAN code for the product. Such codes follow standard formatting. If either code is detected, then the product data may be looked up, as in step 1210 from a standard industry lookup database. Product data may then be obtained from the retrieved data, as in step 1230. If the receipt is devoid of such codes, then the receipt or email is reviewed for product data, such as a merchant name, product identifier, product name, price and date, as in setp 1215. If such information is available and detectable in the receipt, then the information may be extracted for use in the system, as in step 1230. Extraction entails identifying the information using keyword and pattern recognition, and saving and associating the identified information with the type of information (e.g., saving a numerical value as a price, and saving a name as a merchant, and saving an alphanumeric code as a product id). In some cases, an email may not have an attached receipt and may not contain product information. Instead, the email may contain links directed to transaction information on a remote server, as in step 1220. In such cases, the link is followed, as in step 1235. If the followed link leads to the product information, the product information is identified and extracted in steps 1215 and 1230. However, in some cases, the link for the order may lead to separate links for each product in the order. In such case, each product link is followed. If the followed link leads to the product information, the product information is identified and extracted in steps 1215 and 1230. Following links may require the user’s login for an account on the remote server, which the user may supply to the system or enter as needed during the operation. A user may also manually enter data from a receipt as in step 1225.

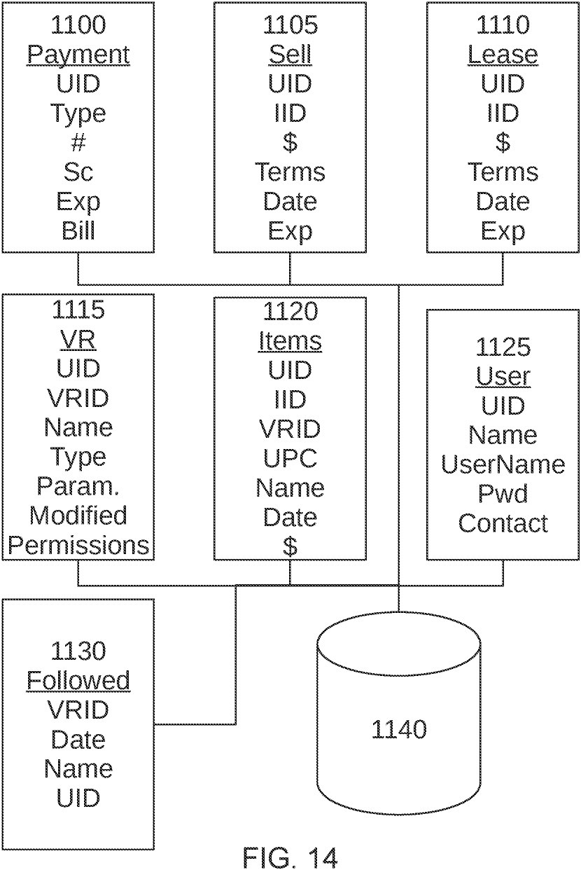

FIG. 14 is a high level data model that conceptually illustrates exemplary data for a virtual repository with item data according to principles of the invention. The data is stored on a data storage device 1140, which may comprise one or more mass storage devices on a remote server, such as 160-170 in FIG. 1. The data may be stored as records in tables of a relational database. Identifications (id)s are unique uniform identifiers assigned to records in the system. Each of a user, virtual repository and item is assigned a unique uniform identifier. The unique uniform identifier may be used to retrieve records pertaining thereto.

Examples of categories (tables) of data include payment data 1100. By way of example and not limitation, the payment data includes a user id to associate the information with the particular user. The payment data includes a type, such as a credit or debit card or an ACH account. The payment data includes an account number. The payment data includes a security code and expiration in the case of cards. The payment data also includes an address such as an account holder or billing address. Such payment data may be used for a user to make purchase using the system. The payment data may be stored by a secure third party system, or securely by the virtual repository system.

As another example of categories of data, are selling records 1105. By way of example and not limitation, the selling records may include data pertaining to items sold by a user using the system, including the user id, item id, amount, terms of sale, date and expiration in the case of a pending offer to sell. Similarly, records of rentals 1110 may be kept, including such data as the user id, item id, amount, terms of rental, date and expiration in the case of a pending offer to rent.

As another example of categories of data, are virtual repository records 1115. By way of example and not limitation, the virtual repository records may include the user id, a virtual repository id, a name for the virtual repository, a type description for the virtual repository, data for parameters for the virtual repository, dates last modified, and permissions (e.g., sharing permissions) relating to the virtual repository.

As another example of categories of data, are item records 1120. By way of example and not limitation, the item records may include the user id, an item id, a virtual repository id, a product code such as a UPC code, a name for the item, and a date for the item, among other data. Such other data may include descriptions, comments, affiliate program links, photographs and pictograms for the item.

As another example of categories of data, are user data 1125. By way of example and not limitation, a user data record may include the user id, a name, a user name, a password and contact information, including a mailing address, email address, telephone numbers and the like. Other data may include biographical information, comments, and photographs.

Item records may correspond to items owned or used by a user; items used in settings (e.g., shows, scenes, live events) with which a user is associated; and/or items otherwise associated with a user. A user is an account holder, which may be, by way of example and not limitation, an individual, group of individuals, entity or association.

A user may follow other shared virtual repositories and/or items. By way of example and not limitation, a celebrity user may share his or her virtual repository. Other users may follow the shared virtual repository. Following allows a user quick access to the shared virtual repository, by selecting it from a list of followed virtual repositories. The list may be sorted in order of frequency of visit, last visited, alphabetically, or chronologically. Followed records 1130 may include a virtual repository id, one or more dates (e.g., dates first followed, last visited dates, dates of each visit), a repository name, and the following user’s id.

A trigger is an important aspect of an exemplary implementation of the invention. A trigger is a user command, a request, seeking data for a target. The target is another user. The item data sought may be item data for items in current use by the target, item data for items in use by the target at a specific event, or item data owned by the target. The item data includes only data shared by the target.

The trigger may be any of various types of user input. The trigger may be a control selection using a graphical user interface. The trigger may be typed data. The trigger may be a voice command or gesture input on a touch sensitive device. The trigger may be a photograph, a video, a voice recording uploaded to the system or created using the system. The trigger may be a scanned (e.g., photographed) product code or inputted product identification. The trigger is not limited to any particular format or means of input.

A trigger may be specific or contextual. A specific trigger identifies at least the target user. A specific trigger may also include additional information, such as a time and location. A contextual trigger indicates an occurrence from which a target may be selected or determined. By way of example and not limitation, such an occurrence may be an event, a location and time, a broadcast show or commercial, an advertisement.

In one nonlimiting example, the command is a selection of a target or a target’s shared virtual repository or items. For example, a user may be interested in what items are included in a celebrity’s shared virtual repository, or what shared items are currently in use by a celebrity. In such case, the user may select a link to the target’s shared items or virtual repository. The link may have been included in search results, or previously saved (e.g., bookmarked) by the user, or found by navigating through an index, or found in some other manner that identifies the target.

In another example, a user may be interested in what items a person in the vicinity of the user is using (e.g., what a person is wearing). Illustratively, a target in the vicinity of a first user may be wearing attire or an item of apparel or accessory that interests the user. The first user may select a control for identification of all other users in the first user’s vicinity who have shared items or shared virtual repositories. Location information (e.g., GPS data) from the first user’s device may be used to determine the first user’s location. The “vicinity” may comprise an area within a determined range of the location. The determined range may be set by default or set and/or adjustable by the first user. If there is more than one other user in the first user’s vicinity, the first user may be presented with a list of links to shared user data, from which the first user can browse and/or select a target.

Alternatively, the first user may photograph or video a target. From the location information from the first user’s device, and the photograph, the first user may be presented with a list of links to shared user information, from which the first user can select the target. An implementation using video recognition or sound may filter the list to shared user information for one or more users who are associated with the recognized video or sound.

In some implementations, after a target is identified, the system determines if the identified target is a user. If the person is a user, then the system may provide one or more links to shared data of the targeted user. Such shared data may include shared personal information, shared item data and a shared virtual repository. In other implementations, it is clear that a target is a user, and, therefore, this determination is unnecessary. For example, a user may select a target from a search of other users.

As described above, a user may purchase items that are shared by a target. Also, as described above, the target may receive a reward, e.g., an affiliate fee, from a vendor for items purchased by a user. Thus, a system and method according to principles of the invention potentially rewards targets for sharing item and virtual repository data, improves sales by merchants who reward referral business from targets, and facilitate purchasing decisions by consumer-users who admire a target’s items and/or virtual repository.

Referring again to FIG. 1, a device such as a tablet 135, smartphone 120, computer 140 or smart television 175, may display an image or a video (media) selected by a user. For example, in one implementation, the media may be an advertisement, commercial, a broadcast or streamed program, video or movie. An icon, link, button, and/or other similar selection mechanisms may be provided, as a trigger, to enable a user to select a scene or page, and/or to mark (e.g., with a cursor) a face of a person in the media. The selection device may be a remote control in the case of television, a paired smartphone, in the case of a smart TV, or any available input device in the case of a computer, tablet or smartphone.

A video may be a broadcast television program, a program streamed on demand or some other motion picture recording. An image or photo may be a photo taken with a user’s device, or a photo accessed by a user from an accessible source (e.g., a photo obtained from the Internet) or a photo provided to the user’s device by another person (e.g., a photo transmitted to the user by email or SMS).

Identifying information may facilitate identification of subjects of a video or photo. By way of example, in the case of a broadcast program, the broadcaster (e.g., ABC, CBS, NBC, FOX, etc...) locale and time of broadcast may be used to identify the program. Such information is available from broadcasters, guides (e.g., television program guides) and data aggregators such as GraceNote. The identification of all individuals appearing in an identified program may also be determined from information available for the program, from such sources. Similarly, in the case of a movie, the identification of all individuals appearing in an identified movie may be determined from information available for the movie, movie databases. Knowing the identity of individuals appearing in the video facilitates identification of the person of interest to the user, whether by facial, video, sound or speaker recognition, or by user selection from a list of actors, actresses, performers, hosts, guests, news anchors, reporters, and the like.

In one embodiment, a database 170 includes temporal data for movies and television programs. Temporal data correlates time with appearing individuals. Thus, all appearing individuals are associated with time values indicating when the individuals appear in the video. The time value may be relative (e.g., relative to the start of the video at 0.0 hr, 0.0 min, 0.0 sec) or, for a broadcast program, actual time (e.g., at 3:45pm EST). In this manner, determining the time of a scene of interest to a user reveals the individuals appearing in the scene. In this manner, the list of individuals may be greatly reduced from the full cast. Such reduction facilitates identifying a person of interest.

In the case of a photo, metadata may include location and time data. A database API may include event data, identifying an event, attendees, performers, locations, and times. The data may also include user location data, including historical location information and times. In this manner, a user appearing in the photo may be readily identified with or without facial or video recognition.

In one embodiment, information regarding a selected scene is provided to the user. By way of example and not limitation, a database of program information may contain the names of actors in each program. For a television program the time, location and channel may be used to determine the program. The time and location may be determined from a user’s computing device. The tuned channel may be determined from a smart TV, smart cable box or smart satellite receiver via communication with a paired smart phone or other computing device, or by user input.

In another implementation, video recognition may be applied to all faces in a selected scene or to a selected face in a scene. A copy of the scene or a copy of the image of the selected face may be communicated from the device (e.g., tablet 135, smartphone 120, computer 140 or smart television 175) to a server (e.g., server 155) for facial recognition processing using facial recognition software.

In another embodiment, a user may play a sound recording or stream, which is another form of media. A speaker in the recording or stream may be identified by manual input from the user, or by speaker recognition.

A sound may include a voice or speach, voice recognition, and more particularly speaker recognition may be used to determine the identity of a speaker in a recording. An exemplary speaker recognition process compares a speech sample against previously created voice prints to determine the best match(es). Technologies used to process and store voice prints include frequency estimation, hidden Markov models, Gaussian mixture models, pattern matching algorithms, neural networks, matrix representation, vector quantization and decision trees. Noise reduction algorithms can be employed to improve accuracy. As a nonlimiting example, Microsoft Azure’s Speaker Recognition is a speech service that verifies and identifies speakers and may be incorporated into software. Other non-limiting examples include GoVivace’s Speaker Identification software and Oxford Wave Research Ltd.’s Vocalise speaker recognition software.

Using an application on a portable computing device, such as a smartphone, a consumer selects a trigger. The exemplary method accepts various triggers. A target trigger requests information associated with at least one virtual repository of the plurality of virtual repositories assigned to an identified user. An event trigger requests virtual repository information for one or more users appearing at a scheduled event. A location trigger requests information for one or more users at the same location (which includes the vicinity) as the location of the first user who submitted the trigger. A media trigger contains an image, video, video trigger, or sound recording, from which a user’s identity is determined via video or sound recognition and video or sound recognition. A product trigger identifies a product and seeks links to users and/or virtual repositories that contain item records that corresponds to the product. A directive trigger includes a condition, which, when satisfied, causes the computing system to send results that include responsive details. A video trigger includes a media trigger, captured media, and may include image, video, and sound recognition technology to identify a television, video, or a theater screen when initiated. When a trigger is initiated, cropping of the television, video, or theater screen may begin to filter out everything outside the program itself to prevent incorrect recording, video recognition, or fingerprinting or mapping of a video. In all cases, displayed results may be filtered and sorted by the user. A recorded speaker may be a recorded sound. A recorded image may also be a recorded video. Image recognition many also be video recognition. Speaker recognition may also be sound or audio recognition.

Services associated with a virtual repository may also include, but not limited to buildings with leasing options or purchasing options to office space, residential space, businesses that sell services and location information. The user might be interested in detail information of the type of dog or cat in the captured media and the breeder of the dog or cat in the captured media with location and purchasing information. The user might be interested in a movie shown as a video trailer in a TV commercial and would like a reminder to see the movie or a reminder to purchase tickets or an option to purchase pre-sale tickets now. Those are several examples of captured services from a program or video program. All virtual repository information may be associated with product or service details, product or services links or product or service codes, or entertainment information. An object or matching object may be an item or item record. Services may be an item or item record. An object may be a numerical timestamp or duration value. An object or matching object may be a movie or television show scene. A matching object or object may be participant, participant details may include an image, product details, movie details, TV show details, scene information, business information, personal information, numerical timestamp, colors, sizes, prices, services details, entertainment or TV guide schedule information, company logos, television or streaming channels, product categories, brand and retailer information. A user may also be a participant. A user may also be a viewer. Each user account may come with user personal information or business information.

During a video trigger, a television may be detected using image recognition technology. Once detected, the technology may crop the television edges and begin recording the video within the cropped edges of the television.

An exemplary fingerprinting method and engine, as in step 25, converts an audio signal into a sequence of relevant features. In a first step, preprocessing, captured audio is digitized if necessary and converted to a specific format. Next, in framing, the signal is divided into frames of a determined size. The number of frames computed per second is the frame rate. Next, a linear transformation is applied to transform the set of frames to a new set of features, preferably one that reduces redundancy. By way of example and not limitation, Fast Fourier Transform (FFT), Discrete Cosine Transform (DCT), Haar Transform or Walsh-Hadamard Transform may be applied. Next, feature extraction is performed to reduce dimensionality and increase invariance to distortions. By way of example, with knowledge of the transduction stages of the human auditory system, more perceptually meaningful parameters may be extracted through a critical-band analysis of the spectrum. Mel-Frequency Cepstrum Coefficients (MFCC) may be used. A Spectral Flatness Measure (SFM), which estimates tone-like or noise-like quality for a band in the spectrum, may be used. Band representative vectors, an ordered list of indexes of bands with prominent tones (i.e. with peaks with significant amplitude), may be used. Energy of each band may be used. Other approaches from music information retrieval, which include features that have proved valid for comparing sounds: harmonicity, bandwidth, loudness, zero crossing rates, may also be used. These and other methods of characterizing the transformed content may be utilized. To better characterize temporal variations, high order time derivatives may added to a signal model. A low resolution quantization may also be applied to the features to gain robustness against distortions, normalize, ease hardware implementations, reduce the memory requirements and for convenience in subsequent parts of the system. The result of these initial steps is sequence of feature vectors calculated on a frame by frame basis. Next, the fingerprint is modeled, such as by summarizing the multidimensional vector sequences in a single vector. By way of example and not limitation, 16 filtered energies may correspond to 30 seconds of audio ending up with a signature of 512 bits. The signature along with information on the original audio format is sent to a server for identification. Illustratively, a vector may include the average zero crossing rate, the estimated beats per minute (BPM), an average spectrum and some more features to represent a piece of audio. This approach is computationally efficient and produces a very compact fingerprint. Fingerprints can also be sequences (traces, trajectories) of features. Assuming that features of a given audio item are similar, a compact representation may be generated by clustering feature vectors. The sequence of vectors is thus approximated by a much lower number of representative code vectors, e.g., a map or table.

Video fingerprinting entails capturing video, transforming the input video data into a transform domain (e.g Radon transform, Fourier Mellin Transform) that is invariant under geometric operations before extracting robust features from the domain. First, the input video is temporally downsampled to a reference frame rate. One or more frames are downsampled to reference spatial resolution. A sub-image is cropped out from down sampled images. A low-pass filtering operation is performed on the frame to improve robustness of extracted features.

Video fingerprinting provides a small number of pertinent features from video clips, called fingerprints, and to identify a video query by measuring the distance between a query fingerprint and fingerprints in a database. Feature extraction for video fingerprinting may entail extracting global features and/or local features. Global features mean that the fingerprints come from the whole video frame. A color histogram may be used to represent each individual frame in a captured video. A Centroid of Gradient Orientation (CGO) may be calculated for each block, and then an M-dimensional vector of the centroids may be used as a fingerprint for a video frame. Global features may be extracted from spatial domain, and/or the transform domain. For example a multi dimensional compact Fourier-Mellin transform (CFMT) signature may be extracted for each keyframe, and matrix may be formed as a final fingerprint for the keyframes. In contrast to considering global features, local features focus on the local structure of video frame. Local features can cope with rescaling, cropping, adding logos and picture-in-picture, etc. As one example, a Harris interest point detector may be used to extract interest points in each keyframe, and a differential feature of the local region around each interest point may then used as the fingerprint. Extracting features not only spatially but also over time makes the fingerprints more discriminative as well as better localized. Illustratively, a spatial-temporal interest points detector may detect interest points. Local fingerprints are extracted by computing a contrast context histogram in local regions around each interest point which is to evaluate the intensity differences between the center pixel and the other pixels.

As one example, an input video clip may be converted to grayscale and resized to fixed width and height values. Then, local regions are detected in the resized video clip using a spatiotemporal interest point detector. Then, the input video clip is resampled at a fixed frame rate. Then, a local region is selected in each down-sampled frame according to the characteristic strength and scale of the interest point, and then a contrast content histogram is calculated in each selected local region. After normalizing each contrast content histogram to a set of unit vector, the unit vectors may be used as local fingerprints to represent the input video clip. During a video trigger, a television may be detected using image recognition technology. Once detected, the technology may crop the television edges and begin recording the video within the cropped edges of the television and create a Percipient Sample Pack (PSP), captured media, to send to the Media Information Module (MIM) and then the Virtual Repository Matching Module (VRM). A fingerprint or a watermark may also be created or digitized by the detection of color patterns, Item patterns, shadows, brightness, contrast, speed of changes, speed of scene changes, speed of camera changes, wavelengths, frequencies, distance between the participants or objects all from the captured media or program from a video trigger and/or captured media by the user. Fingerprint and watermarks can be created or digitized using a combination from one or more detections from the video recording or captured media.

The MIM sends the user identification and program information to a Virtual Repository Matching Module (VRM), where a video or audio fingerprint is then made available for searching. The objective is to search the fingerprint database to find a match, a match between the fingerprint for the captured media and a fingerprint stored in the database for a segment of a program. Any searching technique suitable for comparing or determining a distance metric between the fingerprint and a large number of reference fingerprints may be used. Distances may be computed between the feature sequence extracted from the captured audio and reference audio fingerprints stored in a repository using a distance or scoring metric. The most likely reference in the database is selected. In some cases, the system may detect more than one match or reference sent over in the Percipient Sample Pack (PSP) and list them for the user on their portable computer device. The user will then select the program they are watching at the current moment to see the users, items, and/or services associated to the captured media. To efficiently complete comparisons of the fingerprint for a captured audio against possibly millions of fingerprints one or more techniques may be applied to identify the most likely reference audio fingerprints. For example, an index of certain pieces of a fingerprint may be used to generate a list of candidate reference audio fingerprints, which may then be efficiently exhaustively searched. Heuristics similar to those used in computational biology for the comparison of DNA may be used to speed up a search in the system where the fingerprints are sequences of symbols or values.

After a program and a segment of the program is identified, another database is searched to determine participants (e.g., actors, hosts, guests, producers) or item records, particularly those associated with the captured portion,. The participant and/or item database, which may be stored locally or accessed remotely, relates participants to programs and to scenes. After the participants are identified, the virtual repository may be queried.

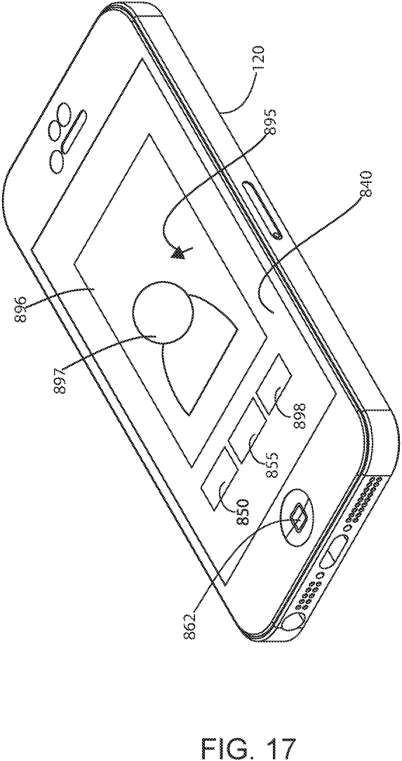

Referring to FIG. 17, a display 840 of a device 120 may display image/video 896 or play a sound recording or stream. Display 840 may include mark face icon, link, button 898, and/or other similar selection mechanisms, which upon selection may enable a user to mark (e.g., in one implementation, with cursor 895) a portion of the face 897 of image/video 896. In the case of a sound recording or stream, the selection mechanism may mark a speaker. If the face is marked with cursor 895, facial recognition may be performed on the image/video 896. If a sound recording or stream is marked, speaker recognition may be performed. In one implementation, facial recognition may be performed on image/video 896 with facial recognition software provided in the device (e.g., via processing logic and storage of device 120). In another implementation, facial recognition may be performed on image/video 896 with facial recognition software provided on a device communicating with device 120 (e.g., a remote computing system 155 via network communication). Likewise, speaker recognition may be performed on the device 120 or on a remote device 155.

In lieu of video or sound recognition, a user may enter or select a name of the person in the image/video 896. If the user knows the name of the person, and/or the image/video 896 is poor resolution, and/or facial recognition is unavailable, user entry of the person’s identity is a viable option.

Results of the facial recognition of image/video 896, or speaker recognition, or user entry, may be provided on display 840. Results may include a list of the person(s) matching the face shown in image/video 896 or identity entered by the user. For example, in one implementation, results may include a celebrity name and/or image and an indication of the closeness of the match of celebrity (e.g., a 98% chance that celebrity matches with image/video 896) to the processed image/video 896. The displayed name and/or image may be a link and/or pictogram, leading to the celebrity’s shared virtual repository and/or shared items.

Results may be arranged in various ways. For example, in one implementation, the results may include a disambiguation list if an entered identity may correspond to more than one person. The disambiguation list may include a list of names and/or images, which may be links and/or pictograms. As another example, results may include a list of matching persons in descending order from the closest match to a person matching within a predetermined percentage (e.g., 50%). A user may select a person from results to display a shared virtual repository or shared items of the person.

In each example, the results list includes names of people who are users of a system according to principles of the invention. The results list omits non-users. Thus, a system according to principles of the invention may determine if a named person or facially or voice recognized person is a user.

An invitation for a non-user identified by user entry or facial or voice recognition may be generated by the system. The invitation is a message to the non-user, inviting and encouraging the non-user to become a user of the system. The invitation may be sent by the requesting user, and/or by the system. The invitation may be sent to the non-user’s known email address and/or social media account(s).

A system according to principles of the invention may also determine if a named person, or facially or voice recognized person is a user with a shared virtual repository and items. If a named or recognized user lacks a shared virtual repository and items, the list may include a control (e.g., icon) to invite the user to share his/her virtual repository and items.

In another aspect of an exemplary implementation of the invention, a location-based trigger is used. A location based trigger uses location information from a user’s device. Such location information is described above. The trigger may be activated by user command (e.g., selection of a control). The system determines if other users are at the same location, or in the vicinity. The determination is made using location information from each user’s smart phone or similar device. If other users are at the same location, or in the vicinity, the system provides a results list or graphical display, for display on the user’s device. In one implementation, the results include a list of users at the location and/or in the vicinity. The list may identify users by name and/or photo. The displayed name or photo may be a link or a pictogram that directs to the displayed user’s shared virtual repository and/or items.

Illustratively, a user may be in a public space, such as a bar, a mall, a store, a street, a restaurant, a park or the like. The user may see another person who is wearing clothes that interest the user. The user may initiate (e.g., select) a location based trigger control. Upon receiving a location based trigger command, the system receives the user’s location information from the user’s device. The system then searches its location records for all other users at the location or in the vicinity of the location. As discussed above, the vicinity is a system or user-defined range, such as, for example, a 250 m radius. GPS-enabled smart phones are typically accurate to within about 4.9 m (16 ft.) radius under open sky. However, their accuracy worsens near buildings, bridges, and trees, and indoors.

As long as a user does not disable location tracking, the system receives location information from each user’s device (e.g., each user’s GPS-enabled smart phone). In one implementation, the system maintains location records for a user indefinitely or for a determined time and in determined time increments. Historical location records are useful for identifying a user who was present at or in the vicinity of a location, but recently left.

Upon determining the users at and in the vicinity of the location, at the current time and recently, e.g., up to five minutes earlier, the system generates results for display on the device of the triggering user. The results may be displayed in a list or graphically. A list may include user names and/or photos linked to each user’s shared virtual repository and or items. Tools may be provided to sort and filter the list. By way of example and not limitation, sorting tools may sort the results according to spatial proximity (e.g., distance from location) of each identified user, and/or according to time, i.e., temporal proximity, and/or according to fame as described below, and/or according to another distinguishing category (e.g., gender, race, age range, height range, etc...).

Fame may be measured according to follower activity. The system may track each visit to a user’s shared virtual repository and items by other users. The higher the number of such visits, the greater the popularity of the user’s shared virtual repository. Such number of visits may be used as a measure of fame. Another measure of fame tracked by the system may be the number of unique users who visit the user’s shared virtual repository and items. The higher the number of such unique visitors, the greater the popularity of the user’s shared virtual repository. As another measure of fame, the system may track affiliate rewards (e.g., compensation) to a user. As discussed above, affiliate rewards are received by a user for click through purchases from the user’s shared virtual repository and/or items. The higher the number of such purchases, the greater the fame. The measure of fame may also be a composite (combination) of visits, unique visits and affiliate rewards, which would not only indicate traffic to a virtual repository, but traffic that results in sales. The system may also track when such visits and/or affiliate awards are made, to distinguish among past popularity, current popularity and consistent popularity. Each measure of fame may be limited to recent visits, e.g., visits in the past 30, 90, 120 or 180 days. Celebrities will likely earn high levels of fame.

Categories for filtering and sorting results (e.g., a results list) may include gender, race, approximate age (e.g., range of ages such as 40-49), height (e.g., range of heights such as 6′ or greater), proximity (e.g., outer limit such as within 100 m radius), fame (e.g., top 100) and other distinguishing categories. By way of example and not limitation if a user is interested in the clothing worn by a nearby Asian woman, who happens to be a user, and appears to be about 30 years old and about 5′ 4″, the interested user may filter all males, all non-Asians, all people 40 or over, and all people over 5′ 10″. If the woman was within 10 m of the user, the interested user may also filter all people more than 25 m away. Such filters allow a cushion for error in approximation. As another example, the user may be primarily interested in any famous users in the vicinity. Thus, the interested user may filter, from the result list, all users who have a determined level of fame or less, or all users but the top 5, 10, 50 or 100 most famous users, leaving only the most famous users in the results list.

In each case, a results list includes links (or pictograms) that direct to shared virtual repositories and/or items of a sharing user. A user who follows such a link (i.e., a following user), may purchase one or more shared items, provided that the shared items are available from linked merchants. Such purchases may be initiated by selecting purchase links associated with the items. The selection may direct to a merchant website where the item may be purchased. Via an affiliate program, as described above, the sharing user may be rewarded for the purchase. In this manner, sharing users are rewarded for promoting items, such as by including items in their shared virtual repository, and by wearing or using items in public where other users may acquire an interest upon witnessing the user and/or the items being worn or in use. The sharing user becomes a live advertisement for the items. Traffic to a merchant’s website may appreciably increase due to such advertising. Sales of the shared items are also likely to increase.

Another type of trigger is a product trigger. Upon selecting a product trigger control, a user may input identifying information for a product. The information may be a brand and product code, a universal product code (UPC), a European article number (EAN), or other identifying information for a product. The system database 170 may include, for each user, item identifying information. The prospects of affiliate rewards from product triggers and earning fame encourage users to supply such identification information. Upon receiving the identifying information for a product from the triggering user, the system references records in the database 170 to determine users associated with shared items that are the same as the identified product. The system then returns, to the device of the triggering user, a results list and related data. The results list identifies other users who possess the product and have shared item information for the product. The results list may be sorted and filtered by the triggering user. In this manner, the user may determine if many users possess the product, if celebrity users possess the product, what other products such users possess, where such users are located, what are their age, gender, race, and other information relating thereto. The user may also purchase the product through another user’s shared virtual repository, to give the other user an affiliate reward. Users may develop reciprocal relationships to foster affiliate rewards among the users.

In another aspect of a method and system according to principles of the invention, a user may research one or more other users. Such research may entail querying (e.g., searching) database records or exploring through indices. Such results in a list may be sorted and filtered to focus interest, as described above. A user interested in researching footwear popular among other like users would likely find that young men in a rural farming community favor different footwear than young men in a major metropolitan area. Illustratively, a user may search for users who possess Adidas Yeezy sneakers. The user may filter the search results by locale, user age, and any other filtering criteria. The results will show how popular such sneakers are among the listed users, after filtering.

In another aspect of a method and system according to principles of the invention, a user may enter information for an event, appearance, show, or program (collectively, an “event”) into the database 170. By way of example, a celebrity user may appear at an event. Information about the event may be entered after the event is scheduled. The information may include a name for the event, a location for the event, a date and time for the event, and any other information to describe and distinguish the event. Such user may also specify items in the user’s shared virtual repository that the user will wear or use during the event. Such user may also specify that the event information be immediately shared, but that information regarding items used/worn by the user at the event not be shared until the event occurs. In this manner, other users may research the event and the participating user, and that user’s shared virtual repository and items. Illustratively, a celebrity may appear as a guest on a talk show, an event. The celebrity, or an assistant for the celebrity, may input information about the event and specify the attire worn by the celebrity during the event, with the attire being items from the celebrity’s shared virtual repository. Using a system according to principles of the invention, fans of the celebrity may follow the celebrity’s shared virtual repository, and consider purchasing one or more of the items worn by the celebrity during the event.

In another aspect of a method and system according to principles of the invention, a user may enter a directive. A directive may identify another user (e.g., a celebrity), a virtual repository, an item or other identifiable classificatory division of subject matter that is of interest or desired by the user providing the directive. The directive identifies the user, the subject matter of interest and provides an instruction. The instruction may request notification when another user’s (e.g., a specific celebrity’s) virtual repository is changed, or when another user (e.g., a celebrity) schedules an event, or when some other condition is satisfied. A directive may be persistent, valid until canceled. Thus, for example, a user may request notification whenever a celebrity schedules an event or changes her virtual repository.

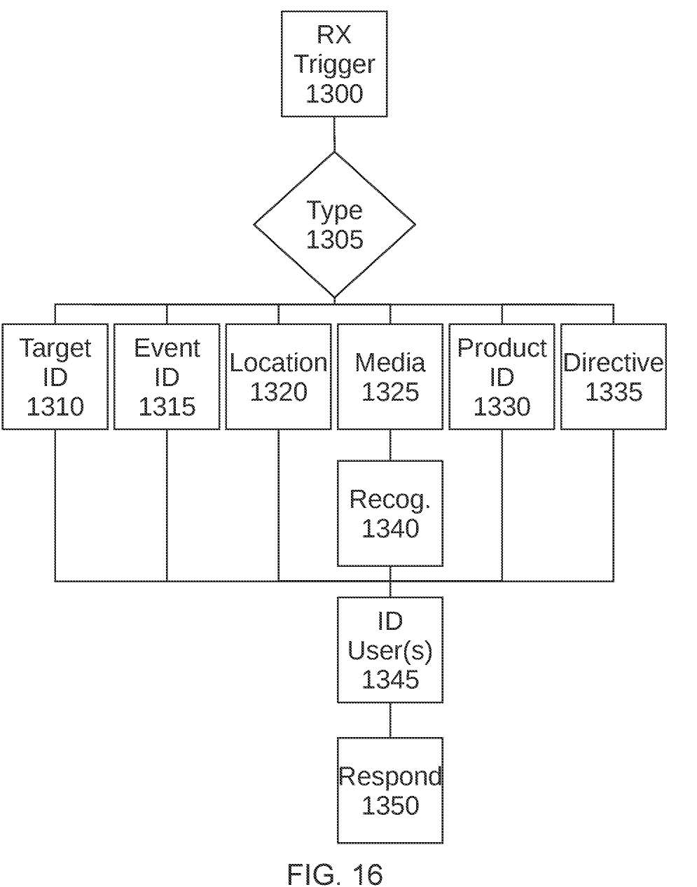

Referring to FIG. 16, a high level flow chart is provided for an exemplary triggering process according to principles of the invention. The process entails receiving a trigger, as in step 1300. The type of trigger is determined in step 1305. A target trigger provides a target identification, which is the identification of a user of interest, as in step 1310. An event trigger identifies an event attended by a user, as in step 1315. A location trigger identifies a location of a user, seeking identification of other users in the area, as in step 1320. A media trigger provides media (e.g., an image such as a photo, a video or a sound recording) from which a displayed or speaking person is to be identified, as in step 1325. A product trigger provides an item identification, which is of interest to the requesting user, as in step 1330. A directive, identifies the user, the subject matter of interest and provides an instruction, as in step 1335. In the case of a media trigger, as in step 1325, video or sound recognition may be performed, as in step 1340. In each case a one or more users may be identified in response to the trigger, as in step 1345. In response to the triggering user, a results list is provided, as in step 1350. The results list may list one or more other users.

Implementations consistent with principles of the invention may identify media based on facial and/or voice recognition results for the media, and may display identification information based on the facial and/or voice recognition results. By using media identification (e.g., facial recognition technology to identify a person(s) in images and/or video, and/or voice recognition technology to identify a person(s) in audio, e.g., a sound byte from a recording), a person(s) may be identified and shared virtual repository data may be displayed on a device.

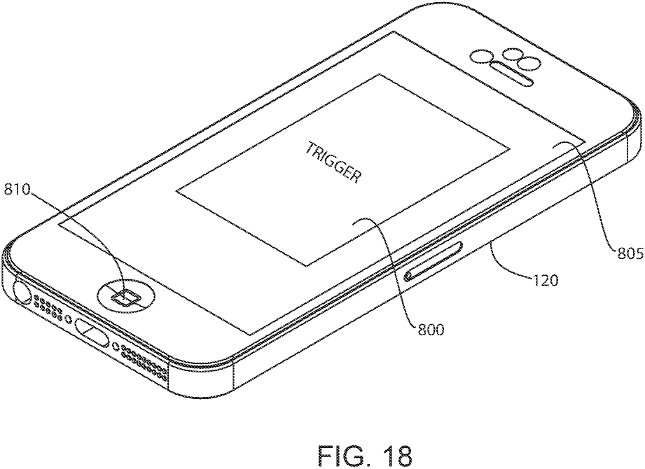

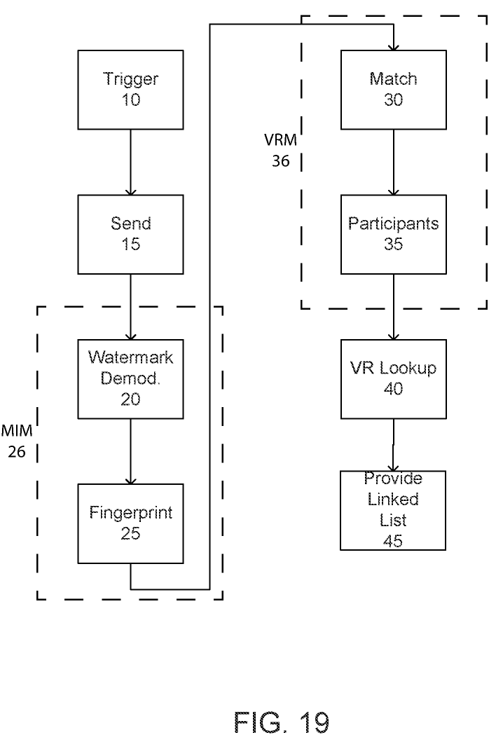

FIG. 18 conceptually illustrates an exemplary user device 120 on which a method and system according to principles of the invention may be used. The exemplary device includes a touchscreen 805 and a microphone 810. A camera may also be provided, with one or more lenses on the opposite side of the device. A graphical user interface may be presented on a touchscreen 805. The user interface may present a trigger control 800, such as the shown rectangle. Touching the rectangle may activate the trigger operation. The trigger operation initiates the method described below with reference to FIG. 19.

With the virtual repository created and populated with data, including records corresponding to objects used in programs, such as TV shows, movies, events and the like, the virtual repository may be queried for such records. Referring to FIG. 19, using an application on a portable computing device 120, such as a smartphone, a consumer selects a trigger, as in step 10. The trigger creates a percipient sample pack (PSP). The PSP may include a user identification, location information, time information and captured media (i.e., recorded audio and/or video). The application may be configured to capture audio (sound) or video, or the application may allow a user to select whether to capture audio or video. Thus, the PSP contains information and captured media. The user identification, location information, time information are PSP information. The captured media is PSP media. The captured media is recorded audio and/or video of a target. The target is a television program (e.g., a show or movie), a streamed program, or a program from another source, such as a recording medium (e.g., a DVD), the Internet or a program delivery service that provides content by network communication. The captured media is a portion of the target, i.e., a portion of interest to the user. The user may be interested in the participants who appear in the captured media, the garments or accessories they are wearing, items they are using or other objects that appear in the captured media. Captured audio may be preferred, as it does not require a clear line of sight to the display, is not lighting sensitive and consumes considerably less storage space and bandwidth than an equivalent duration of captured video.

In step 15, the smartphone application sends the PSP to a remote computing system 155, which includes a media identification module (MIM) 26, comprised of one or more computer programs. The MIM 26 receives and processes the PSP or the captured media of the PSP to determine if the captured media contains a watermark and/or to generate a fingerprint of the captured media.

When captured media is comprised of captured video, the media may be cropped to eliminate elements that are not part of the broadcast or streamed video of interest. By way of example, the frame or bezel of a television screen may be cropped out of (i.e., removed from) the captured video. Thus, fingerprinting will take into account only the recorded segment of the video of interest. This invention is not limited to a particular cropping methodology. In one nonlimiting example, regions of interest are detected. These may be regions that contain moving objects and/or pixel color changes. Such movement and changes may be determined by comparing contiguous frames. The cropped area may encompass a cluster of regions of interest, including moving object regions and color change regions. If cropping is employed for captured video recorded with a trigger, then similar cropping may be performed to video segments comprising a reference fingerprint database.

A watermark is a signal (e.g., an audio signal that is imperceptible to humans) that is included in the audio or video of a program. By way of example, companies who track which programs are watched by users have implemented technology that allows broadcasters and other distributors to embed watermarks in the audio. Live broadcast and streamed content may include a watermark to track content distribution from its origin to its final destination. This may be accomplished through the insertion of a unique content identification code at a distribution center. The content identification code may be a second-by-second serial number used to uniquely identify delivered content. The code may be transmitted by modulating one or more carrier wave signals to encode digital information. The carrier wave signals may comprise sounds, inaudible to humans. Demodulating the appropriate frequency range of captured sounds provides the code. If a watermark is detected, it is demodulated to extract the modulated information, as in step 20. The program (i.e., show, movie, TV commercial, or event) may be identified from a database or similar repository that relates known watermarks to programs. The database may be stored locally 170 or accessed remotely via network communication. The watermark may not only identify the program but also provide a timing component that indicates the part of the program.

A database of program (e.g., show, movie and event) fingerprints may be stored locally 170. The database relates fingerprints to programs. A program may have a plurality of fingerprints, each fingerprint corresponding to a segment of the program. The method used to generate each fingerprint in the fingerprint database is also used to generate a fingerprint for the captured media in the PSP, as in step 25. The fingerprint for the captured media in the PSP may then be compared with fingerprints in the fingerprint database to find a match, as in step 30. The match reveals the program and the portion of the program that corresponds to the fingerprint.

A fingerprint is a unique proxy or signature (e.g., a series of digital values, a waveform, etc.) generated from characteristics of the captured media. The fingerprint may be compared to a set of reference fingerprints corresponding to known programs. When a substantial match is found, the program and portion of the program that contains the captured media can be identified with a relatively high probability.

The invention is not limited to a specific fingerprint methodology. Any fingerprint methodology that efficiently generates a unique fingerprint for each captured media and for segments of each program in the database may be utilized. In one exemplary implementation the fingerprint is comprised of information (e.g., a sequence of vectors) that efficiently and accurately describe the captured media. A searching engine then compares the generated fingerprint to those in a repository of reference fingerprints, for matching, such as by using a distance metric. The closest reference fingerprint may be the match.

As used herein, searching and matching for fingerprints entails similarity searching where, given a query object, objects that are “similar” are returned from a database. Matching is not limited to exact matching. Generally, a distance function may be used to measure dissimilarity. Objects that are not dissimilar by more than a range threshold, or, are least dissimilar to the query, are then sought. The distance function measures the dissimilarity between objects. Thus, retrieving an object that is more similar is equivalent to retrieving an object that has a lesser distance.

An exemplary fingerprinting method and engine, as in step 25, converts an audio signal into a sequence of relevant features. In a first step, preprocessing, captured audio is digitized if necessary and converted to a specific format. Next, in framing, the signal is divided into frames of a determined size. The number of frames computed per second is the frame rate. Next, a linear transformation is applied to transform the set of frames to a new set of features, preferably one that reduces redundancy. By way of example and not limitation, Fast Fourier Transform (FFT), Discrete Cosine Transform (DCT), Haar Transform or Walsh-Hadamard Transform may be applied. Next, feature extraction is performed to reduce dimensionality and increase invariance to distortions. By way of example, with knowledge of the transduction stages of the human auditory system, more perceptually meaningful parameters may be extracted through a critical-band analysis of the spectrum. Mel-Frequency Cepstrum Coefficients (MFCC) may be used. A Spectral Flatness Measure (SFM), which estimates tone-like or noise-like quality for a band in the spectrum, may be used. Band representative vectors, an ordered list of indexes of bands with prominent tones (i.e. with peaks with significant amplitude), may be used. Energy of each band may be used. Other approaches from music information retrieval, which include features that have proved valid for comparing sounds: harmonicity, bandwidth, loudness, zero crossing rates, may also be used. These and other methods of characterizing the transformed content may be utilized. To better characterize temporal variations, high order time derivatives may added to a signal model. A low resolution quantization may also be applied to the features to gain robustness against distortions, normalize, ease hardware implementations, reduce the memory requirements and for convenience in subsequent parts of the system. The result of these initial steps is sequence of feature vectors calculated on a frame by frame basis. Next, the fingerprint is modeled, such as by summarizing the multidimensional vector sequences in a single vector. By way of example and not limitation, 16 filtered energies may correspond to 30 seconds of audio ending up with a signature of 512 bits. The signature along with information on the original audio format is sent to a server for identification. Illustratively, a vector may include the average zero crossing rate, the estimated beats per minute (BPM), an average spectrum and some more features to represent a piece of audio. This approach is computationally efficient and produces a very compact fingerprint. Fingerprints can also be sequences (traces, trajectories) of features. Assuming that features of a given audio item are similar, a compact representation may be generated by clustering feature vectors. The sequence of vectors is thus approximated by a much lower number of representative code vectors, e.g., a map or table.

Video fingerprinting entails capturing video, transforming the input video data into a transform domain (e.g Radon transform, Fourier Mellin Transform) that is invariant under geometric operations before extracting robust features from the domain. First, the input video is temporally downsampled to a reference frame rate. One or more frames are downsampled to reference spatial resolution. A sub-image is cropped out from down sampled images. A low-pass filtering operation is performed on the frame to improve robustness of extracted features.

Video fingerprinting provides a small number of pertinent features from video clips, called fingerprints, and to identify a video query by measuring the distance between a query fingerprint and fingerprints in a database. Feature extraction for video fingerprinting may entail extracting global features and/or local features. Global features mean that the fingerprints come from the whole video frame. A color histogram may be used to represent each individual frame in a captured video. A Centroid of Gradient Orientation (CGO) may be calculated for each block, and then an M-dimensional vector of the centroids may be used as a fingerprint for a video frame. Global features may be extracted from spatial domain, and/or the transform domain. For example a multi dimensional compact Fourier-Mellin transform (CFMT) signature may be extracted for each keyframe, and matrix may be formed as a final fingerprint for the keyframes. In contrast to considering global features, local features focus on the local structure of video frame. Local features can cope with rescaling, cropping, adding logos and picture-in-picture, etc. As one example, a Harris interest point detector may be used to extract interest points in each keyframe, and a differential feature of the local region around each interest point may then used as the fingerprint. Extracting features not only spatially but also over time makes the fingerprints more discriminative as well as better localized. Illustratively, a spatial-temporal interest points detector may detect interest points. Local fingerprints are extracted by computing a contrast context histogram in local regions around each interest point which is to evaluate the intensity differences between the center pixel and the other pixels.

As one example, an input video clip may be converted to grayscale and resized to fixed width and height values. Then, local regions are detected in the resized video clip using a spatiotemporal interest point detector. Then, the input video clip is resampled at a fixed frame rate. Then, a local region is selected in each down-sampled frame according to the characteristic strength and scale of the interest point, and then a contrast content histogram is calculated in each selected local region. After normalizing each contrast content histogram to a set of unit vector, the unit vectors may be used as local fingerprints to represent the input video clip. During a video trigger, a television may be detected using image recognition technology. Once detected, the technology may crop the television edges and begin recording the video within the cropped edges of the television and create a Percipient Sample Pack (PSP), captured media, to send to the Media Information Module (MIM) and then the Virtual Repository Matching Module (VRM). A fingerprint or a watermark may also be created or digitized by the detection of color patterns, Item patterns, shadows, brightness, contrast, speed of changes, speed of scene changes, speed of camera changes, wavelengths, frequencies, distance between the participants or objects all from the captured media or program from a video trigger and/or captured media by the user. Fingerprint and watermarks can be created or digitized using a combination from one or more detections from the video recording or captured media.

The MIM sends the user identification and program information to a Virtual Repository Matching Module (VRM), where a video or audio fingerprint is then made available for searching in step 30. The objective is to search the fingerprint database to find a match, a match between the fingerprint for the captured media and a fingerprint stored in the database for a segment of a program. Any searching technique suitable for comparing or determining a distance metric between the fingerprint and a large number of reference fingerprints may be used. Distances may be computed between the feature sequence extracted from the captured audio and reference audio fingerprints stored in a repository using a distance or scoring metric. The most likely reference in the database is selected. In some cases, the system may detect more than one match or reference sent over in the Percipient Sample Pack (PSP) and list them for the user on their portable computer device. The user will then select the program they are watching at the current moment to see the users, items, and/or services associated to the captured media. To efficiently complete comparisons of the fingerprint for a captured audio against possibly millions of fingerprints one or more techniques may be applied to identify the most likely reference audio fingerprints. For example, an index of certain pieces of a fingerprint may be used to generate a list of candidate reference audio fingerprints, which may then be efficiently exhaustively searched. Heuristics similar to those used in computational biology for the comparison of DNA may be used to speed up a search in the system where the fingerprints are sequences of symbols or values.

After a program and a segment of the program is identified, another database is searched to determine participants (e.g., actors, hosts, guests, producers) or item records, particularly those associated with the captured portion, as in step 35. The participant and/or item database, which may be stored locally 170 or accessed remotely, relates participants to programs and to scenes. After the participants are identified, the virtual repository may be queried.

In step 40, the VRM searches a database or other repository for records of participants, i.e., virtual repository users (e.g., individuals or items that appeared in the captured media and others associated with the captured media) associated with the identified program, and, in particular, with the portion of the program that contains the captured media. The user accounts of the identified users are then searched to identify shared records of items that appeared in the captured media. Thus, for example, records for an actor’s attire worn in the scene, or for an accessory or object used in the scene and identified in a production company’s virtual repository, may be identified.

In step 45, a hierarchical linked list is then made accessible for display on the portable computing device of the consumer who selected the trigger. The list may include a first page that displays links to each participant-user who has an account in the virtual repository. Such users may include acting professionals, news professionals, hosts, guests, and management (e.g., a producer) of a program for which the media was captured. Selecting link for such a user leads to linked information for item records associated with scene corresponding to the captured media. The item records are records of items that are in the user’s virtual repository and are associated with the program, and, in particular, the portion of the program for the captured media. The items may also be linked. Selecting a link for an item may lead to additional information for the item including purchasing information. By way of example, the link may lead to a site for purchasing the item. In some examples, through the site a consumer may purchase or bid in an auction to purchase the authentic item used in the program, which may come with a certificate of authenticity such as a printed certificate, electronic certificate or a non-fungible token (NFT), i.e., a unique digital identifier that cannot be copied, substituted, or subdivided, that is recorded in a blockchain, and is used to certify authenticity and ownership. Alternatively, the link may lead to a retail site through which such an item may be purchased. Thus, the trigger leads to items of interest used in the scene for which the trigger was activated. The items or services on the scene or captured media of the program from the second user’s virtual repository is activated when the first user’s portable computer device is triggered and activated. The items and services from the second user’s virtual repository will then be sent to the first user’s portable computer device and listed and displayed for product detail information including a purchasing and action bidding option.

In some examples, through the site a consumer may purchase or bid in an auction to purchase the authentic item used in the program, which may come with a certificate of authenticity such as a printed certificate, electronic certificate or a non-fungible token (NFT), i.e., a unique digital identifier that cannot be copied, substituted, or subdivided, that is recorded in a blockchain, digital wallet, and is used to certify authenticity and ownership of the user, item, and the proof of purchase associated to the program or/and professional actor wearing the item and NFT may include the inventory or/and inventory count in numerical order in which the item was purchase from the program. The NFTs may be valued like memorabilia. For example, valuing the first, second, and third item purchased from the program more valuable than the ninety-eighth, ninety-ninth, and one hundredth item purchased from the program (e.g, Product Number). The NFTs are sent to the user, owner, or/and purchaser through a digital or computerized system after the purchase of each item from the program. The NFT may include user or professional actor, brand of item, retailer selling the item, category of the item (e.g., shirt, jacket), program name (e.g., Mission Impossible, Legally Blond), product name, product purchase number, color, size, price, date, time, and current owner (user that made the purchase or user whom which the item was purchase for). Alternatively, the link may lead to a retail site through which such an item may be purchased.

Through an affiliate program, a user may earn compensation (e.g., a commission) for each item purchased through such a link. In this manner, consumers are efficiently provided links to purchase items of interest that appear in a program, while actors, production companies and others associated with a program are compensated for garnering consumer interest and facilitating sales of the items, all without any explicit marketing and without any direct communication between the consumer and user.

In sum, in one exemplary implementation, a computer-implemented method of object linking from captured media entails, on a portable computing device, creating a pack including captured media, and sending the pack to a media identification module. Through the media identification module, a first fingerprint is generated for the captured media, the first fingerprint being unique to the captured media. Fingerprint generation may, optionally, entail transforming the captured media into a transform domain. Through a remote computing system, a fingerprint database configured to relate predetermined fingerprints to a plurality of programs is accessed. A plurality of predetermined fingerprints relates to each program of the plurality of programs. Through the remote computing system, a search is performed for a matching fingerprint among the predetermined fingerprints. A distance between the matching fingerprint and the first fingerprint is less than the distance between the first fingerprint and any other predetermined fingerprint of the fingerprint database. From the plurality of programs, a matching program and program scene related to the matching fingerprint is identified. Through the remote computing system, a participant and product database are accessed. The participant and product database relates participant and item records to programs and scenes. A search is performed for a matching participant, the matching participant being a participant record related to the matching program and scene. Through the remote computing system, a virtual repository is accessed. The virtual repository is a database that relates user records to object records and relates object records to program records. A search is performed for a matching user. The matching user is the user record for the matching participant. Matching objects are identified. The matching objects are object records related to the matching user and related to the matching program. A link to each matching object is sent to the portable computing device, and may include a link to an online retailer for each matching object to the portable computing device. A non-fungible token may be associated with at least one matching object, as a certificate of authenticity, which may be important if an authentic object is acquired.

In another embodiment a watermark is embedded into the captured media. The watermark may be a sound imperceptible to humans. The sound may be modulated to encode data. Through the media identification module, the watermark may be demodulated. Then the demodulated watermark may be searched in a watermark database that relates watermarks to programs and/or scenes of programs. If the program and scene are identified using this method, then fingerprinting may be unnecessary, but may optionally be carried out for confirmation.

The invention improves the functioning of a computer by providing means to automatically connect trigger information, including captured media, with object records for objects that may then be the subject of further transactions. This is an improvement in the computing and content delivery (e.g., broadcasting, streaming, movie theater) fields that did not heretofore exist. The invention is achieved by implementing sequential MIM/VRM operations to connect object records to captured media. The sequential MIM/VRM detects and demodulates any embedded watermark, fingerprints the captured audio or video for matching in a database of fingerprints for scenes (portions) of programs, identifies participants for the scene from a database that relates participants such as actors and producers to programs and scenes of the program, and identifies object records associated with the program or scene from the participants’ virtual repository accounts. The selection of a trigger control captures media (audio and/or video), as part of a PSP, which effects a transformation, namely the identification of object records, from the PSP, for further transactions. Heretofore, no such automated means of connecting object records to a scene associated with the captured media existed. The object records enable linking for useful purposes.

The various databases described herein may comprise distinct separate databases, may be combined into one or more databases, or may comprise parts of larger databases. Thus, by way of example and not limitation, a participant database may be combined with a virtual repository. Similarly, a watermark database and fingerprint database may be combined into a multi-purpose database. Thus a database should not be construed to be limited to a distinct separate database, but, rather, may include any database that includes tables and relationships required to provide the described functionality.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, while series of acts and/or steps have been described, the order may be modified in other implementations consistent with principles of the invention. Further, non-dependent acts may be performed in parallel. Still further although implementations described above discuss use of facial and voice biometrics, other biometric information (e.g., fingerprints, eye retinas and irises, hand measurements, handwriting, gait patterns, typing patterns, etc.) may be used to identify people and provide corresponding virtual repository information.

The term “comprises/comprising” when used in this specification is taken to specify the presence of stated features, steps or components but does not preclude the presence or addition of one or more other features, steps, components or groups thereof.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with principles of the invention is not limiting of the invention. Thus, the operation and behavior of the aspects were described without reference to the specific software code-it being understood that one of ordinary skill in the art would be able to design software and control hardware to implement the aspects based on the description herein.

No element, step, or instruction referenced in this application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A computer-implemented method of managing a virtual repository system, the method comprising:
a computing system storing a plurality of virtual repositories, each virtual repository of the plurality of virtual repositories being associated with a user of a plurality of users, and each virtual repository of the plurality of virtual repositories including item records for items owned and used by at least one user of the plurality of users, and the plurality of virtual repositories including a first virtual repository associated with a first user, and a second virtual repository associated with a second user; and
the computer system receiving a selection of a first item record of the second virtual repository;
the computing system receiving a first trigger, the first trigger requesting first information and the first trigger including media information, the media information including video data associated with a second virtual repository; and
the computing system performing video recognition on the video data and identifying the second user;
the computing system sending results to a first computing device, the results including a link to a first item record of the second virtual repository, the first item record of the second virtual repository being responsive to the first trigger.

2. The computer-implemented method of claim 1, wherein the step of receiving on the computing system a first trigger from a first computing device of the first user includes receiving on the computing system a first trigger that includes a request for information associated with at least one virtual repository of the plurality of virtual repositories associated with an identified user.

3. The computer-implemented method of claim 1, wherein the second user is associated with an event, the event being an event associated with the second user; and, during the event, the second user using items for which the second virtual repository includes item records, and wherein the step of receiving on the computing system a first trigger from a first computing device of the first user includes receiving on the computing system a first trigger that includes a request for information associated with the event; and the step of sending results from the computing system to the first computing device includes sending an identification of the second user and an affiliate link for an item record of the second virtual repository.

4. The computer-implemented method of claim 1, wherein the first trigger includes location information, the location information identifying a location of at least one of the first user and the second user at a first time at which the first trigger is received on the computing system, and the second user being in a determined vicinity of the location at the first time, and the results identify the second user, and the results provide an affiliate link for an item record of the second virtual repository; and the method further comprising:
the first user selecting the affiliate link on the first computing device; and
providing a reward to the second user.

5. The computer-implemented method of claim 1, wherein the first trigger includes location information, the location information identifying a location of the first user at a first time at which the first trigger is received on the computing system, and the results identify a plurality of users, excluding the first user, in a determined vicinity of the location at the first time, and the results provide a link to a selected item record from each virtual repository for each user of the identified plurality of users.

6. The computer-implemented method of claim 1, the results associating the first item record to a non-fungible token.

7. A computer-implemented method of managing a virtual repository system, the method comprising:
a computing system receiving a plurality of virtual repositories, each virtual repository of the plurality of virtual repositories being associated with a user of a plurality of users, and each virtual repository of the plurality of virtual repositories including item records for items owned and used by at least one user of the plurality of users, and the plurality of virtual repositories including a first virtual repository associated with a first user, and a second virtual repository associated with a second user; and
the computer system receiving a selection of a first item record of the second virtual repository;
the computing system receiving a first trigger, the first trigger requesting first information and the first trigger including media information, the media information including recorded sound data associated with a second virtual repository; and
the computing system performing sound recognition on the sound data and identifying the second user;
the computing system sending results to a first computing device, the results including a link to a first item record of the second virtual repository, the first item record of the second virtual repository being responsive to the first trigger.

8. The computer-implemented method of claim 7, the results associating the first item record to a non-fungible token.

9. The computer-implemented method of claim 1, wherein the first trigger includes a directive, the directive including an instruction, ; and
the step of sending results from the computing system to the first computing device comprising sending results from the computing system to the first computing device in response to the directive.

10. The computer-implemented method of claim 1,
displaying the results on the first computing device,
filtering the results on the first computing device, the filtering excluding a first portion of the results from display on the first computing device.

11. The computer-implemented method of claim 1
each virtual repository of the plurality of virtual repositories including a virtual repository identification;
for a first virtual repository of the plurality of virtual repositories, the computing system, receiving, via network communication, item records from a plurality of third party sources, said third party sources including a remote merchant sales computing system, the item records being records of items acquired by the user;
the computing system merging the received item records;
the computing system storing the merged received item records in a cache;
the computing system presenting to the first user the merged received item records stored in the cache;
the first user, via the first computing device, validating the merged received item records stored in the cache as presented by the computing system; and
the computing system associating the validated merged received item records stored in the cache with the first virtual repository; and
the computing system storing the validated merged received item records on a storage device.

12. The computer-implemented method of claim 11, wherein the step of the computing system merging the received item records comprising merging received item records into a table, each item record comprising a plurality of fields.

13. The computer-implemented method of claim 12, wherein the step of the computing system merging the received item records further comprising extracting data from the received item records, the step of extracting including identifying and storing data for the fields of each item record.

14. The computer-implemented method of claim 11, each item record including at least one of a photograph of an item.

15. The computer-implemented method of claim 11, further comprising the computing system associating an affiliate link with at least one of the validated merged received item records.

16. The computer-implemented method of claim 11, further comprising using the first computing device to search emails for item records, and providing the item records from searched emails to the computing system for merging with the received item records.

17. The computer-implemented method of claim 16, further comprising a software component on the first computing device monitoring browser activity for item records, and providing the item records from browser activity to the computing system for merging with the received item records.

18. The computer-implemented method of claim 17, further comprising receiving manually input item records on the first computing device, and providing the manually input item records to the computing system for merging with the received item records.

19. The computer-implemented method of claim 1, wherein the results include a link to an ordered table of data from item records associated with at least one virtual repository of the plurality of virtual repositories.

20. The computer-implemented method of claim 1, wherein the results include a link to navigable graphic representation of the virtual repository.
